(19) United States
(12) Patent Application Publication
(10) Pub. No.: US 2026/0209528 A1
(43) Pub. Date: Jul. 23, 2026

(54) SUPRAMOLECULAR BINDERS

(71) Applicant: Conamix Inc., Ithaca, NY (US)

(72) Inventor: Stephen Burkhardt, Ithaca, NY (US)

(21) Appl. No.: 19/139,546

(22) PCT Filed: Dec. 19, 2023
(86) PCT No.: PCT/US2023/084786

§ 371 Date: Jun. 16, 2025

Related U.S. Application Data
(60) Provisional application No. 63/434,006, filed on Dec. 20, 2022.

(51) Int. Cl. C09D 5/24; C08F 8/34; C09D 7/62; C09D 133/02; C09D 139/00; H01M 4/136; H01M 4/36; H01M 4/58; H01M 4/62

(52) U.S. Cl. CPC C09D 5/24; C08F 8/34; C09D 7/62; C09D 133/02; C09D 139/00; H01M 4/136; H01M 4/366; H01M 4/5815; H01M 4/622; H01M 4/625

(57) ABSTRACT

The present disclosure provides aqueous binders that address challenges associated with simple linear polymer binders. In some embodiments, a binder includes Lewis acid sites and Lewis base sites that chemically interact. Different species, such as two different types of polymers or a linear polymer and particle (e.g., made of a different polymer), can be used. A first species may have only Lewis acid sites in (e.g., on) it and a second species may have only Lewis base sites in (e.g., on) it. In some embodiments, linear polymer comprising Lewis base sites (e.g., in its backbone) and polymer particles comprising Lewis acid sites are used to form a supramolecular binder where the Lewis acid sites and the Lewis base sites are chemically interacting. In some embodiments, cationic and anionic polymers are used to form a binder with chemically interacting Lewis acid sites and Lewis base sites.

### CROSS-REFERENCE TO RELATED APPLICATION

This application claims priority to U.S. Provisional Application No. 63/434,006, filed on Dec. 20, 2022, which is hereby incorporated by reference in its entirety.

### TECHNICAL FIELD

This disclosure relates generally to binders. In some embodiments, the binders are for electrochemically active material for electrodes for use in electrochemical cells.

### BACKGROUND

Lithium-based batteries utilize electrodes that are generally a combination of electrochemically active material, conductive carbon and binder. Generally, the binder and conductive carbon content are minimized in order to achieve the highest energy and/or power density possible for the cell. This typically balances the mechanical properties of the cathode (e.g., adhesion, bend radius, cohesion) with energy density. In instances where cathode particles in a film have high surface area, more binder may be needed due to binder affinity with particle surfaces.

The binders used in Li-ion batteries are typically linear polymers, soluble in aqueous or organic solvents. Aqueous solvents are generally preferred because of low toxicity, low environmental impact, low cost, and because they obviate the need for expensive solvent recovery systems. Linear polymers are generally less suitable for applications requiring high mechanical strength vs cross-linked polymers. This is due to generally lower cohesive strength between polymer chains in linear polymers. Moreover, high strength linear polymers are typically not soluble in aqueous solutions.

Additionally, cathode blends for use in lithium sulfur batteries are typified by the inclusion of significant amounts of high surface area conductive carbon which makes optimizing binder content challenging. For example, achieving good mechanical properties typically requires a relatively high mass fraction of binder content due to the high surface area of the cathode solids, however this leads to occlusion of surfaces, a lowering of the overall surface area per unit volume, and a diminution in energy density. Because charge transfer occurs from the surfaces of conductive cathode components to the electrochemically active sulfur, reduced surface area can lead to lower capacity and rate capability.

### SUMMARY

The present disclosure provides binder systems that address challenges associated with simple linear polymer binders. The binders can have high strength while being processable in aqueous solvents. To accomplish these objectives, among others, binders disclosed herein utilize chemical interactions between Lewis acid sites and Lewis base sites. Different species, such as two different types of polymers or a linear polymer and particle (e.g., made of a different polymer), can be used. A first species may have only Lewis acid sites in (e.g., on) it and a second species may have only Lewis base sites in (e.g., on) it. In some embodiments, a linear polymer comprising Lewis base sites (e.g., in its backbone) and polymer particles comprising Lewis acid sites are used to form a supramolecular binder created by interactions of Lewis acid sites and the Lewis base sites. Accordingly, in some embodiments, a binder defines (e.g., forms) a supramolecular polymer network in the composition formed by interacting Lewis acid sites and Lewis base sites. In some embodiments, cationic and anionic polymers are used to form a binder with chemically interacting Lewis acid sites and Lewis base sites. Binders disclosed herein have been incorporated in cathode compositions for lithium-sulfur batteries that demonstrated unexpectedly large improvements in cycle life, cell impedance growth, and/or energy density.

Chemical interaction between Lewis acid sites and Lewis base sites (e.g., on different species) can act like a non-covalent crosslink, thereby providing benefits typically associated with chemical crosslinking without the need for forming covalent crosslinks. Thus, manufacture of electrode compositions can be simplified by using binders disclosed herein. Covalent crosslinks typically require additional processing steps, such as a photoinitiation process or high temperature thermal treatment to form the crosslinks. In some embodiments, a binder disclosed herein may be formed during slurry-based deposition of an electrode composition without the need for any further cross-linking steps. In some embodiments, a first species is provided that includes Lewis acid sites or Lewis base sites and which is soluble in a solvent (e.g., water) along with a second species that includes Lewis base sites or Lewis acid sites (respectively) is insoluble in the solvent. This provides options for providing the insoluble species as part of a cathode solid which in turn offers a valuable level flexibility in cathode manufacturing methods. The difference in solubility can inhibit premature interaction between the first species and the second species that may otherwise cause early precipitation of an insoluble product with non-uniform or poor binding characteristics. The present disclosure includes the recognition that certain commonly used and available polymer salts, such as poly(diallyldimethylammonium chloride) (PDADMA-Cl), are actually water soluble and therefore may lead to such premature precipitation if used. By forming PDADMA with other counterions, (or by using metathesis to substitute chloride with alternate anions, the solubility of PDADMA polymers can be modulated—in particular to provide PDADMA polymers that are not water soluble. Such water-insoluble PDADMA polymers can then be combined during cathode processing with water soluble polymers (e.g., anionic polymers) to form effective cathode binders. This approach of manipulating or changing counterion identity can be applied to other commonly used and available polymer salts to alter their solubility (e.g., substitute an anion to make a polymer salt water insoluble).

The present disclosure additionally recognizes that batteries based on cathode active materials (e.g., sulfur) potentially yield higher performance when alternate (e.g., more polar) electrolyte solvents are used. However, many of these solvents cannot be used with cathodes that use traditional binders, since such solvents dissolve typical cathode binders and lead to physical failure of the cathode film. For example, amide solvents, such as n-methyl pyrrolidone, are able to dissolve polyvinylidene fluoride (PVdF), so while amides may be desirable for use as a component in a sulfur electrolyte to improve energy or power, they cannot be substituted without developing a more resilient binder. Certain binders disclosed herein are not soluble in amide solvents and therefore cathodes containing such binders enable use of such solvents in battery electrolytes. In general, binders disclosed herein enable selection from a wider choice of electrolytes than traditional binders.

In some aspects, the present disclosure is directed to an electrode (e.g., cathode) composition for a (e.g., lithium sulfur) battery. The composition may include an electrochemically active material and a binder. The binder may include chemically interacting Lewis acid sites and Lewis base sites.

In some embodiments, the binder comprises two different species, each comprising either the Lewis acid sites or the Lewis base sites. In some embodiments, one of the two different species is a polymer (e.g., an ionomer) and the other of the two different species is a particle (e.g., a nanoparticle). In some embodiments, the particle is a silica particle, a metal oxide particle, a carbon particle, a metal sulfide particle, or a metal fluoride particle. In some embodiments, the particles are porous (e.g., mesoporous). In some embodiments, the two different species are different polymers (e.g., two ionomers). In some embodiments, one of the two different species is a cationic polymer and the other of the two different species is an anionic polymer.

In some embodiments, the binder in the composition forms a network of nodes, where such nodes are sites at which the Lewis acid sites and the Lewis base sites are chemically interacting. In some embodiments, the binder comprises two different species, one of which comprises the Lewis acid sites and the other of which comprises the Lewis base sites.

In some embodiments, such binders are derived from a first species that comprises either the Lewis acid sites or the Lewis base sites and is soluble in an aqueous solvent, and a second species that is insoluble in aqueous solution and comprises complementary Lewis basic sites or Lewis acidic sites respectively, [e.g., wherein the water-insoluble species is a particle (e.g., nanoparticle)]. In some embodiments, the first (water soluble) species comprises the Lewis acid sites and the second (insoluble) species comprises the Lewis base sites. In certain such embodiments, the binder is introduced into the composition as an aqueous slurry that comprises a dissolved first (water-soluble) species and the second (water-insoluble) species that is a solid (e.g., particle) in suspension. In some embodiments, the soluble (first) species comprises the Lewis base sites and the suspended solid (second) species comprises the Lewis acid sites (e.g., wherein the binder is introduced into the composition as a slurry that comprises the water-soluble Lewis base species and the water-insoluble Lewis acid species that is a particle). In some embodiments, the soluble (first) species comprises the Lewis acid sites and the suspended solid (second) species comprises the Lewis base sites (e.g., wherein the binder is introduced into the composition as a slurry that comprises the water-soluble Lewis acid species and the water-insoluble Lewis base species that is a particle). In some embodiments, the binder forms upon mixing the water-soluble species and a water insoluble species. In certain embodiments, the binder forms upon complete or partial drying of a slurry that contains water-soluble Lewis acidic or basic species and a complementary water insoluble Lewis acidic or basic species.

In some embodiments, a first species comprises either the Lewis acid sites or the Lewis base sites and is soluble in an aqueous solvent, and wherein a different, second species comprises the other of the Lewis acid sites and the Lewis base sites and is insoluble in aqueous solution [e.g., wherein the water-insoluble species is a particle (e.g., nanoparticle)]. In some embodiments, the first species comprises the Lewis acid sites and is water-insoluble and the second species comprises the Lewis base sites and is water-soluble (e.g., wherein the binder is introduced into the composition as a slurry that comprises the water-soluble second species and the water-insoluble first species that is a particle). In some embodiments, the binder comprises a water-soluble portion and a water insoluble portion that are chemically interacting.

In some embodiments, the binder comprises particles comprising only the Lewis acid sites or only the Lewis base sites. In some embodiments, the binder comprises linear polymer comprising only the Lewis acid sites or only the Lewis base sites. In some embodiments, the binder comprises one or more polymers having the Lewis acid sites and/or the Lewis base sites incorporated into the polymer backbone(s) in the form of functional groups. In some embodiments, the binder defines (e.g., forms) a supramolecular polymer network in the composition. In some embodiments, the binder comprises a neutral species (e.g., containing boron, nitrogen, or phosphorous centers) that comprise the Lewis acid sites or the Lewis base sites.

In some embodiments, the binder comprises a species that decorates a surface of the electrochemically active material. In some embodiments, the electrochemically active material comprises particles and the binder comprises a species that decorates the particles.

In some embodiments, the electrochemically active material comprises one or more members selected from the group consisting of sulfur (e.g., sulfur in its S₈ cyclic octatomic molecular form), selenium, lithium sulfide (e.g., Li₂S₂ and/or Li₂S), a chalcogenide (e.g., a metal sulfide), an organosulfur, and alloys or mixtures of any two or more of these.

In some embodiments, the composition includes an electron conducting material (e.g., a conductive carbon). In some embodiments, the binder comprises a species that decorates a surface of the electron conducting material. In some embodiments, particles comprise the electron conducting material and the binder comprises a species (e.g., Lewis acidic or Lewis basic species or functional group) that decorates the particles. In some embodiments, the electron conducting material is a conductive carbon powder (e.g., carbon black, Super P®, C-NERGY™Super C65, Ensaco® black, Ketjenblack®, acetylene black, synthetic graphite such as Timrex® SFG-6, Timrex® SFG-15, Timrex® SFG-44, Timrex® KS-6, Timrex® KS-15, Timrex® KS-44, natural flake graphite, graphene, carbon nanotubes, fullerenes, hard carbon, and/or mesocarbon microbeads).

In some embodiments, a provided binder comprises a member selected from the group of cationic polymers. In certain embodiments, such cationic polymers are polymers containing ammonium groups (e.g., tetra-alkyl ammonium groups). In certain embodiments, such cationic polymers are polymers containing cationic heterocyclic groups, (e.g., pyridinium, imidazolium, pyrrolidinium, and the like). In certain embodiments, such polymers comprise poly(diallyldimethylammonium), poly(3vinylimidazolium), or poly(pyridinium phenylene) compositions. Such cationic polymers further comprise anions to balance their positive charges. In certain embodiments, cationic polymers are provided as defined salts comprising one or more anions such as a carboxylate, sulfonate, halide, anionic imide-type anions, phosphate, sulfate, sulfite, sulfide, borate, thiosulfate, thionate, a thiocarboxylate, a dithiocarbamate, nitrate, nitrite, xanthate, thiocarboxylate, dithiocarboxylate, carbonate, monothiocarbonate, dithiocarbonate, trithiocarbonate, fluorophosphate, thiophosphate, and the like. In certain embodiments, such polymers a provided as defined salts with anions selected from: trifluoroacetate, trifluoromethanesulfonate, 2-trifluoromethyl-4,5-dicyanoimidazole, bis(trifluoromethane) sulfonimide (“TFSI”), bis fluorosulfonamide (FSI), hexafluorophosphate, iodide, nitrate, acetate, and tetrafluoroborate. In certain embodiments, cationic polymers are provided as TFSI salts. In certain embodiments, cationic polymers are provided as FSI salts. In certain embodiments, cationic polymers are provided as PF₆⁻ salts. In certain embodiments, cationic polymers are provided as BF₄⁻ salts. In certain embodiments, cationic polymers are provided as iodide salts. In certain embodiments, an anion associated with a provided cationic polymer may comprise a polyanionic species. Such polyanionic species may satisfy multiple positive charges in the provided cationic polymers or may further comprise one or more additional cations such a metal ion (for example Li⁺) or another organocation. For example, a counterion in a provided cationic polymer could be LiCO₃⁻.

In certain embodiments, a provided binder comprises a member selected from the group consisting of anionic polymers. In certain embodiments, such anionic polymers comprise anionic functional groups (or functional groups that can be deprotonated to anionic groups) such as carboxylates, sulfonates, phosphates, borates, thionates, thiocarboxylates, carbamates, thiocarbamates, dithiocarbamates, xanthates, thiocarboxylates, dithiocarboxylates, carbonates, monothiocarbonates, dithiocarbonates, trithiocarbonates, fluorophosphates, thiophosphates, and borates, and derivatives, mixtures, and copolymers thereof. In certain embodiments, such polymers comprise polyacrylate, polymethacrylate, polystyrene sulfonate, carboxylate modified polystyrene, and carboxymethyl cellulose. In certain embodiments, anionic polymers are provided as defined salts with cations. Suitable cations include H⁺, metal ions, and ‘onium’ cations containing one or more nitrogen, sulfur, and/or phosphorous atoms. In certain embodiments, anionic polymers are provided as salts with metal cations. In certain embodiments, anionic polymers are provided as salts with alkali earth metal cations (e.g., lithium, sodium, potassium, rubidium or cesium). In certain embodiments, anionic polymers are provided as lithium salts. In certain embodiments, anionic polymers are provided as sodium salts. In certain embodiments, anionic polymers are provided as salts with alkaline metals, or transition metals. In certain embodiments, anionic polymers are provided as salts with organic cations such as ammonium salts, phosphonium salts, or phosphazenium salts. In certain embodiments, such polymers are provided in their protonated form.

In some embodiments, a provided lithium-sulfur battery comprises a cathode that includes an electrode composition disclosed herein (e.g., wherein the electrode composition is disposed as a coating on a current collector).

In some aspects, the present disclosure is directed to a method for manufacturing a composition (e.g., an electrode composition as disclosed herein). The method may include combining components of a binder together in a slurry (e.g., with an electrochemically active material). The components may include a species soluble in the slurry and a species insoluble in the slurry. The method may include chemically interacting the soluble species and the insoluble species to form the binder (e.g., that binds the electrochemically active material).

In some embodiments, the soluble species comprises Lewis base sites or Lewis acid sites and the insoluble species comprises Lewis acid sites or Lewis base sites, respectively. In some embodiments, the chemically interacting comprises interacting the Lewis acid sites and the Lewis base sites. In some embodiments, the soluble species comprises the Lewis base sites and the insoluble species comprises the Lewis acid sites.

In some embodiments, the slurry is an aqueous slurry. In some embodiments, the insoluble species is a particle or a linear polymer. In some embodiments, the soluble species is a polymer (e.g., a linear polymer).

In some embodiments, the method includes, prior to the combining, forming the insoluble species, wherein forming the insoluble species comprises performing a metathesis (e.g., anion metathesis) with precursor materials [e.g., resulting in precipitating product (e.g., the insoluble species]. In some embodiments, the precursor materials comprise one or more materials comprising one or more first anions selected from the group consisting of trifluoroacetate, trifluoromethanesulfonate, 2-trifluoromethyl-4,5-dicyanoimidazole, bis(trifluoromethane) sulfonimide (“TFSI”), bis fluorosulfonamide (FSI), hexafluorophosphate, iodide, nitrate, acetate, and tetrafluoroborate. In certain embodiments, the one or more anions is/are chosen to minimize their mass fraction in the product, thus achieving a higher mass content of cationic polymer units. In some embodiments, the metathesis is performed in water and the insoluble species is insoluble in water. In some embodiments, the metathesis is performed in a non-water solvent and the insoluble species is insoluble in water.

In some embodiments, forming the insoluble species comprises performing a second metathesis (e.g., anion metathesis) (e.g., on the resulting product from the first metathesis) in a non-aqueous solvent (e.g., acetonitrile). In some embodiments, the second metathesis is performed using one or more materials comprising one or more second anions. In some embodiments, the one or more second anions are selected from the group consisting of tetrafluoroborate, hexafluorophosphate, iodide, nitrate, and bis(fluoro) sulfonamide. In some embodiments, the first one or more anions is/are different from the one or more second anions. In some embodiments, the one or more second anions is/are lighter than the one or more first anions. In some embodiments, the one or more first anions is TFSI and the one or more second anions is tetrafluoroborate. In some embodiments, the one or more first anions is TFSI and the one or more second anions is iodide. In some embodiments, the one or more first anions is TFSI and the one or more second anions is nitrate. In some embodiments, the one or more first anions is FSI and the one or more second anions is tetrafluoroborate. In some embodiments, the one or more first anions is FSI and the one or more second anions is tetrafluoroborate. In some embodiments, the one or more first anions is FSI and the one or more second anions is nitrate. In some embodiments, the method includes dissolving resulting product (e.g., precipitate) of the metathesis in the non-aqueous solvent used to perform the second metathesis.

In some embodiments, the method includes decorating an electrochemically active material with the insoluble species prior to the combining. In some embodiments, the method includes forming the insoluble species, wherein forming the insoluble species comprises performing a metathesis in presence of the electrochemically active material (e.g., particles of electrochemically active material) and the decorating occurs during the metathesis. In some embodiments, the metathesis is performed in water and the electrochemically active material is water insoluble (e.g., is a carbon sulfur active material). In some embodiments, the method includes forming the insoluble species, wherein forming the insoluble species comprises performing a first metathesis and a subsequent second metathesis, wherein the subsequent second metathesis, but not the first metathesis, is performed in presence of the electrochemically active material (e.g., particles of electrochemically active material) and the decorating occurs during the second metathesis. In some embodiments, the electrochemically active material is soluble in a solvent used for the first metathesis and insoluble in a solvent used for the second metathesis. In some embodiments, the electrochemically active material is water soluble. In some embodiments, the electrochemically active material comprises a metal sulfide.

In some embodiments, the method includes decorating an electron conducting material (e.g., conductive carbon) with the insoluble species prior to the combining. In some embodiments, the method includes forming the insoluble species, wherein forming the insoluble species comprises performing a metathesis in presence of the electrochemically active material (e.g., particles of electrochemically active material) and the decorating occurs during the metathesis. In some embodiments, the metathesis is performed in water and the electron conducting material is water insoluble.

In some embodiments, the chemically interacting occurs at room temperature and/or in ambient atmosphere. In some embodiments, the chemically interacting occurs spontaneously upon combining the components together.

In some aspects, the present disclosure is directed to a method of preparing a species for use in a binder. The method may include performing a metathesis to substitute a counterion in the species such that solubility of the species in a solvent changes from soluble to insoluble or from insoluble to soluble. In some embodiments, the species changes from soluble in the solvent to insoluble in the solvent. In some embodiments, the method includes performing the metathesis in presence a material (e.g., particles of the material) such that the species decorates the material. In some embodiments, the method includes performing the metathesis in presence a material (e.g., particles of the material) such that the species decorates a surface of the material. In some embodiments, the material is electrochemically active material or electron conducting material.

In some aspects, the present disclosure is directed to a composite comprising a material and a binder, wherein the binder comprises chemically interacting Lewis acid sites and Lewis base sites. In some embodiments, the composition includes particles comprising the material, wherein the binder binds the particles together. In some embodiments, the composition is a film (e.g., self-supporting film) (e.g., coating on a substrate).

Any two or more of the features described in this specification, including in this summary section, may be combined to form implementations of the disclosure, whether specifically expressly described as a separate combination in this specification or not.

### BRIEF DESCRIPTION OF THE DRAWINGS

The present teachings described herein will be more fully understood from the following description of various illustrative embodiments, when read together with the accompanying drawings. It should be understood that each drawing described below is for illustration purposes only and is not intended to limit the scope of the present teachings in any way. The foregoing and other objects, aspects, features, and advantages of the disclosure will become more apparent and may be better understood by referring to the following description taken in conjunction with the accompanying drawings, in which:

FIG. 1A is a schematic of a supramolecular binder, according to illustrative embodiments of the present disclosure;

FIG. 1B is a schematic of a supramolecular binder that includes a particle species, according to illustrative embodiments of the present disclosure;

FIG. 1C is a schematic of a supramolecular binder that includes a particle species, according to illustrative embodiments of the present disclosure;

FIG. 1D is a schematic of a supramolecular binder that includes a polymer species decorating a particle of electrochemically active material, according to illustrative embodiments of the present disclosure;

FIG. 1E is a schematic of a supramolecular binder that includes a particle species decorating a particle of electrochemically active material, according to illustrative embodiments of the present disclosure;

FIGS. 2A-2B are flow charts for methods for forming a binder (e.g., forming an electrode that includes the binder), according to illustrative embodiments of the present disclosure;

FIG. 3A is a cross sectional representation of an electrochemical cell, according to illustrative embodiments of the present disclosure;

FIG. 3B is a cross sectional representation of an electrochemical cell, according to illustrative embodiments of the present disclosure;

FIG. 4 is a perspective representation of a cylindrical battery, according to illustrative embodiments of the present disclosure; and

FIG. 5 is plot of experimental rate ladder results for a cathode constructed using a binder, according to illustrative embodiments of the present disclosure.

FIG. 6 is a bar chart showing the number of cycles to 80% of initial capacity for cells constructed with provided supramolecular binders vs. cells constructed with non-supramolecular binders.

Schematics are not necessarily drawn to scale.

### DETAILED DESCRIPTION OF CERTAIN EMBODIMENTS

Disclosed herein are, inter alia, binders for use in electrochemical cells and methods of forming the binders. The binders may be used, for example, in electrode compositions for electrochemical cells, such as in a cathode. For example, a binder may bind together a solid mixture of materials including electrochemically active species (e.g., present in the form of particles) into a structurally stable electrode film. A provided binder may include chemically interacting Lewis acid sites and Lewis base sites. Using chemically interacting Lewis acid sites and Lewis base sites can obviate the need for physical crosslinks (i.e., that have covalent bonds). In certain embodiments, Lewis acid sites and Lewis base sites are present on different species (e.g., on different polymers or particles). Chemical interactions (e.g., ionic interactions) between the Lewis acid sites and Lewis base sites may then form to create a binder (e.g., during formation of an electrode composition). Accordingly, a binder may include a network of nodes where Lewis acid sites and Lewis base sites are chemically interacting (e.g., ionically interacting). In certain embodiments, the different species may have different solubility in a solvent, for example one may be soluble and one may be insoluble. The difference in solubility may delay interaction between Lewis acid sites and Lewis base sites, to prevent premature precipitation of supramolecular species. In some embodiments, a provided binder defines (e.g., forms) a supramolecular network in an electrode composition. Such binders cn enable use of a reduced amount of binder (e.g., as measured by wt % binder in the electrode, surface area to vol % binder or other metric). In some embodiments, a bend radius test of an electrode prepared with a binder disclosed herein may be improved over an otherwise equivalent electrode prepared with a traditional linear polymer binder. By providing a stronger binder that enables use of lower amounts without detrimentally sacrificing cohesion, there may be reduced surface coverage of components of an electrode held together by a binder, such as electrochemically active materials such as sulfur or metal sulfides, or electron conducting materials such as conductive carbon. In some embodiments, reduced surface coverage on conductive carbon particles can be a benefit for higher performing cells. Such reduced surface coverage may be achieved, for example, where one species in a provided binder is a particle. In some embodiments, a binder includes no covalent crosslinks. In some embodiments, a binder may contribute to ionic conductivity of an electrode.

Lewis acid sites and Lewis base sites are locations such as functional groups in a species that act, or can act, as Lewis acids or Lewis bases, respectively. For example, a polymer may have Lewis acid sites or Lewis base sites incorporated into its polymer backbone (e.g., repeat unit). Lewis acid sites in a polymer may be one or more functional groups, or moieties formed from one or more functional groups, that act as Lewis acids. Lewis base sites in a polymer may be one or more functional groups, or moieties formed from one or more functional groups, that act as Lewis bases. A first species may have Lewis acid sites only and a different, second species may have Lewis base sites only. The first and second species may both be polymers.

Generally, not all Lewis acid sites on a first species will interact with all Lewis base sites on a second species. For example, where a functional group, or moiety formed from a functional group, in a repeat unit of a polymer defines Lewis acid sites or Lewis base sites, not every single repeat unit with chemically interact with corresponding Lewis base sites or Lewis acid sites, respectively, on a second species. Such will clearly not be the case in every embodiment given, for example, the coiled nature of linear polymers. In some embodiments, a species comprising Lewis acid sites or Lewis base sites is neutral. In some embodiments, a species comprising Lewis acid sites or Lewis base sites is ionic (e.g., is an ionic polymer or ionomer). As is known in the art, under some conditions, not all repeat units in an ionomer may be ionized. Therefore, an ionomer may only have Lewis acid sites or Lewis base sites where ionized. When Lewis acid sites or Lewis base sites of an ionomer have been ionized, they can interact (e.g., through ionic interaction) with Lewis base sites or Lewis acid sites, respectively, of a different species.

A species comprising Lewis acid sites or Lewis base sites may be, for example, a polymer or a particle. (A species that “is a particle” may refer to particulate material that includes a plurality of particles (e.g., nanoparticles). Similarly, a species that “is a polymer” may refer to material or composition that includes numerous individual polymer chains (e.g., linear chains). A particle may be a polymer particle, for example formed by precipitating polymer out of solution. In some embodiments, a particle is a silica particle, a metal oxide particle, a metal chalcogenide particle, a carbon particle, a metal fluoride particle, a metal sulfide particle, or a composite particle composed of more than one type of material. In some embodiments, any combination of silica particles, metal oxide particles, metal chalcogenide particles, carbon particles, metal fluoride particles, or composite particles may also be used in a binder. In some embodiments, a particle has a functionalized surface that provides Lewis acid sites or Lewis base sites. A particle may be porous, for example mesoporous. Porous particles may facilitate increased chemical interaction between Lewis acid sites and Lewis base sites in a binder, for example due to increased surface area that exposes additional site(s). A particle may be a nanoparticle. In some embodiments, a polymer species is a linear polymer. Different species of polymer (e.g., linear polymers) may be used in a binder, for example two different ionomers may be used, such as a cationic polymer and an anionic polymer. In some embodiments, particles (e.g., polymer particles or inorganic particles) comprising Lewis acid sites or Lewis base sites are used in combination with polymer (e.g., linear polymer) comprising Lewis base sites or Lewis acid sites, respectively, to form a binder where the Lewis acid sites and the Lewis base sites chemically interact.

In some embodiments, a provided binder comprises or is derived from interaction between a first species that includes either Lewis acid sites or Lewis base sites and is soluble in a solvent, such as water (or, alternatively, non-aqueous solvent) and a different, second species that includes Lewis base sites or the Lewis acid sites, respectively, and which may be insoluble in the solvent. In some embodiments, a water-insoluble species is a particle (e.g., nanoparticle). In some embodiments, a particle is insoluble in a solvent because it is an inorganic, non-polymer species, such as a silica, metal oxide, metal chalcogenide, carbon, composite, or metal fluoride particle. In some embodiments, a provided binder comprises a water soluble portion (e.g., a first species) and a water insoluble portion (e.g., a different, second species) that are chemically interacting. In certain embodiments, the provided binder is the interacting network formed by two such species after the solvent in which the first species is soluble is partially or completely removed.

A species that includes Lewis acidic or Lewis basic sites (e.g., groups) may be a polymer. Non-limiting examples of polymers containing Lewis acid sites and Lewis base sites are described in Progress in Polymer Science Vol. 111, December 2020, 101313 (doi.org/10.1016/j.progpolymsci.2020.101313), the entirety of which is hereby incorporated herein by reference.

A species that includes Lewis acid sites may be a polymer, for example a cationic polymer. A cationic polymer may be provided in a slurry as a salt and then form chemical interactions with Lewis base sites in another species, such as an anionic polymer (e.g., originally provided as a salt). A species (e.g., polymer) comprising Lewis acid sites may be insoluble in a solvent, such as water. In some embodiments, a species comprising Lewis acid sites is soluble in a solvent. A species comprising Lewis acid sites may be a particle, for example particles of cationic polymer or particles containing or coated in cationic polymer may be used in a binder. In certain embodiments, such cationic polymers are polymers containing ammonium groups (e.g., tetra-alkyl ammonium groups). In certain embodiments, such cationic polymers are polymers containing cationic heterocyclic groups, (e.g., pyridinium, imidazolium, pyrrolidinium, and the like). Examples of suitable polymers comprising Lewis acid sites include poly(diallyldimethylammonium), poly(3vinylimidazolium), poly(pyridinium phenylene) compositions, and polymers comprising one or more members selected from the group consisting of pyridinium, imidazolium, piperidinium, phosphonium, and pyrrolidinium (e.g., in a salt form). In certain embodiments, cationic polymers comprise anions to balance their positive charges. In certain embodiments, cationic polymers are provided as defined salts comprising one or more anions such as a carboxylate, sulfonate, halide, anionic imide-type anions, phosphate, sulfate, sulfite, sulfide, borate, thiosulfate, thionate, a thiocarboxylate, a dithiocarbamate, nitrate, nitrite, xanthate, thiocarboxylate, dithiocarboxylate, carbonate, monothiocarbonate, dithiocarbonate, trithiocarbonate, fluorophosphate, thiophosphate, and the like. In certain embodiments, such polymers a provided as defined salts with anions selected from: trifluoroacetate, trifluoromethanesulfonate, 2-trifluoromethyl-4,5-dicyanoimidazole, bis(trifluoromethane) sulfonimide (“TFSI”), bis fluorosulfonamide (FSI), hexafluorophosphate, iodide, nitrate, acetate, and tetrafluoroborate. In certain embodiments, cationic polymers are provided as TFSI salts. In certain embodiments, cationic polymers are provided as FSI salts. In certain embodiments, cationic polymers are provided as PF₆⁻ salts. In certain embodiments, cationic polymers are provided as BF₄⁻ salts. In certain embodiments, cationic polymers are provided as iodide salts. In certain embodiments, an anion associated with a provided cationic polymer may comprise a polyanionic species. Such polyanionic species may satisfy multiple positive charges in the provided cationic polymers or may further comprise one or more additional cations such a metal ion (for example Li⁺) or another organocation. For example, a counterion in a provided cationic polymer could be LiCO₃⁻.

A species that includes Lewis base sites may be a polymer, for example an anionic polymer. An anionic polymer may be provided in a slurry as a salt and then form chemical interactions with Lewis acid sites in another species, such as a cationic polymer (e.g., originally provided as a salt such as a halide, a carboxylate, an TFSI or FSI salt). A species (e.g., polymer) comprising Lewis base sites may be soluble in a solvent, such as water. In some embodiments, a species comprising Lewis base sites is insoluble in a solvent. A species comprising Lewis base sites may be a particle, for example a particle comprising an anionic polymer (e.g., polymers comprising one or more functional groups [or functional groups that can be deprotonated to anionic groups] selected from carboxylates, sulfonates, phosphates, borates, thionates, thiocarboxylates, carbamates, thiocarbamates, dithiocarbamates, xanthates, thiocarboxylates, dithiocarboxylates, carbonates, monothiocarbonates, dithiocaarbonates, trithiocarbonates, fluorophosphates, thiophosphates, and borates, and derivatives, mixtures, and copolymers thereof and combinations of any two or more of these) may be used in a binder. In certain embodiments, such anionic polymers are linear polymers. In certain embodiments, such polymers comprise polyacrylate, polymethacrylate, polystyrene sulfonate, carboxylate modified polystyrene, and carboxymethyl cellulose. In certain embodiments, anionic polymers are provided as defined salts with cations. Suitable cations include H⁺, metal ions, and ‘onium’ cations containing one or more nitrogen, sulfur, and/or phosphorous atoms. In certain embodiments, anionic polymers are provided as salts with metal cations. In certain embodiments, anionic polymers are provided as salts with alkali earth metal cations (e.g., lithium, sodium, potassium, rubidium or cesium). In certain embodiments, anionic polymers are provided as lithium salts. In certain embodiments, anionic polymers are provided as sodium salts. In certain embodiments, anionic polymers are provided as salts with alkaline metals, or transition metals. In certain embodiments, anionic polymers are provided as salts with organic cations such as ammonium salts, phosphonium salts, or phosphazenium salts. In certain embodiments, such polymers are provided in their protonated form.

A provided binder may include a species that is neutral that includes Lewis acid sites or Lewis base sites. The Lewis acid sites or Lewis base sites may chemically interact (e.g., in a non-ionic interaction) with Lewis base sites or Lewis acid sites, respectively, on another species in the binder. For example, in some embodiments a Lewis acid-containing species (e.g., a Lewis acidic polymer species) may include boron centers and a Lewis basic species may interact with those boron centers in a binder. In some embodiments a Lewis base-containing species (e.g., a Lewis basic polymer species) may include neutral nitrogen or phosphorous centers and a Lewis acidic species may interact with those centers in a binder.

A species that includes Lewis acid sites or Lewis base sites may decorate a surface of an electrochemically active material. The electrochemically active material may be present in the form of particles. Particles that include electrochemically active material may be, for example, nanoparticles, microparticles or a combination thereof. Particles that include electrochemically active material may be, alternatively or additionally, microporous, mesoporous, nanoporous, or any combination thereof. Particles that include electrochemically active material may include (e.g., be) flakes, rods, tubes, ellipsoid (e.g., spherical) particles, core-shell particles, or a combination thereof and may be composites of two or more materials one or more of which may comprise the Lewis acid or base sites. In some embodiments, a species that includes Lewis acid sites decorates a surface of electrochemically active material, such as, for example, surfaces of particles comprising electrochemically active material. A species that is insoluble in a solvent, such as, for example, water, may decorate a surface of electrochemically active material, such as, for example, surfaces of particles of electrochemically active material. A species that is a polymer may decorate a surface of electrochemically active material, such as, for example, surfaces of particles of electrochemically active material. A species that is a particle may decorate a surface of electrochemically active material, such as, for example, surfaces of particles of electrochemically active material. In some embodiments, an insoluble species (e.g., polymer or particle) decorates particles that include electrochemically active material. In some embodiments, a species that includes Lewis acid sites or Lewis base sites, for example that includes Lewis acid sites, decorates particles that include electrochemically active material. Thus, a species that is soluble and/or includes Lewis acid sites or Lewis base sites, for example Lewis base sites, may form a binder with a species that is insoluble and/or does not include Lewis base sites or Lewis acid sites, respectively, for example Lewis acid sites, that decorates a surface of electrochemically active material (e.g., decorates surfaces of particles of electrochemically active material) (e.g., decorates particles of electrochemically active material). In some embodiments, as described further below, a surface of electrochemically active material may become decorated during a metathesis reaction.

A species that includes Lewis acid sites or Lewis base sites may decorate a surface of an electron conducting material, such as a conductive carbon. Such electron conducting materials may be present in the form of particles. Particles that include electron conducting material may be, for example, nanoparticles, microparticles or a combination thereof. Particles that include electron conducting material may be, alternatively or additionally, microporous, mesoporous, nanoporous, or any combination thereof. Particles that include electron conducting material may include (e.g., be) flakes, rods, tubes, ellipsoid (e.g., spherical) particles, core-shell particles, or a combination thereof. In some embodiments, a species that includes Lewis acid sites decorates a surface of electron conducting material, such as, for example, surfaces of particles of electron conducting material. In certain embodiments, the Lewis acid or Lewis base sites on decorating such particles, may be covalently attached to the material itself, for example carbon (graphite, carbon black, graphene or carbon nanotubes) may be functionalized with anionic or cationic functional groups that act as Lewis acid or Lewis bases interacting with a complementary species to form nodes in the provided binder. A species that is insoluble in a solvent, such as, for example, water, may decorate a surface of electron conducting material, such as, for example, surfaces of particles of electron conducting material. A species that is a polymer may decorate a surface of electron conducting material, such as, for example, surfaces of particles of electron conducting material. A species that is a particle may decorate a surface of electron conducting material, such as, for example, surfaces of particles of electron conducting material. In some embodiments, an insoluble species (e.g., polymer or particle) decorates particles that include electron conducting material. In some embodiments, a species that includes Lewis acid sites or Lewis base sites, for example that includes Lewis acid sites, decorates particles that include electron conducting material. Thus, a species that is soluble and/or includes Lewis acid sites or Lewis base sites, for example Lewis base sites, may form a binder with a species that is insoluble and/or does not include Lewis base sites or Lewis acid sites, respectively, for example Lewis acid sites, that decorates a surface of electron conducting material (e.g., decorates surfaces of particles of electron conducting material) (e.g., decorates particles of electron conducting material). In some embodiments, as described further below, a surface of electron conducting material may become decorated during a metathesis reaction. In some embodiments, a species will decorate both a surface of electrochemically active material and a surface of an electron conducting material.

In some embodiments, a particle species of a binder at least partially (e.g., wholly) encompasses (e.g., surrounds) one or more particles of a material, such as an electrochemically active material or an electron conducting material. In some embodiments, a particle species of a binder at least particles encompasses different species of particles, such as a mixture of electrochemically active material particles and electron conducting material particles. Such particles species may be, for example, polymer particles. For example, particles of poly(diallyldimethylammonium) bis(trifluoromethanesulfonyl)imide (PDADMA-TFSI) (a species having Lewis acid sites) have been observed as at least partially encompassing many carbon particles. In some embodiments, electrochemically active material particles and/or electron conducting material particles may protrude from particles of a particle species in a binder. For example, such particles may be distributed over a surface (e.g., exterior surface, or interior surface if porous) of the particles of the particle species in the binder. In some embodiments, electrochemically active material particles and/or electron conducting material particles are, alternatively or additionally, included in an interior of the particles of the particle species in the binder. Such electrochemically active material particles and/or electron conducting material particles may still function as intended if the material of the particles of the particle species in the binder is appropriate (e.g., is ion-permeable and/or ion conducting and/or electron conducting). Such may be the case especially for particles may of polymer having Lewis acid sites or Lewis base sites.

In certain embodiments, provided binders comprise combinations selected from the non-limiting examples in Table 1.

TABLE 1

| Lewis Acidic Species | Lewis Basic Species |
|---|---|
| PDADMA-Cl | Sodium polyacrylate |
| PDADMA-Cl | Lithium polyacrylate |
| PDADMA-Cl | Sodium polymethacrylate |
| PDADMA-Cl | Lithium polymethacrylate |
| PDADMA-TFSI | Sodium polyacrylate |
| PDADMA-FSI | Sodium polyacrylate |
| PDADMA-PF6 | Sodium polyacrylate |
| PDADMA-Iodide | Lithium polymethacrylate |
| PDADMA-FSI | Lithium polymethacrylate |
| PDADMA-PF6 | Lithium polymethacrylate |
| PDADMA-TFSI | Sodium polystyrenesulfonate |
| PDADMA-FSI | Lithium polystyrenesulfonate |
| PDADMA-PF6 | Lithium polystyrenesulfonate |
| PDADMA-TFSI | polyethylenedithiocarbamate |
| poly(3-vinylimidazolium)-FSI | Sodium polyacrylate |
| poly(3-vinylimidazolium)-TFSI | Lithium polyacrylate |
| poly(3-vinylimidazolium)-Iodide | Lithium polystyrenesulfonate |
| poly(3-vinylimidazolium)-PF6 | Lithium polyacrylate |
| Poly(pyridinium phenylene)-Cl | Sodium polyacrylate |
| Poly(pyridinium phenylene)-FSI | Lithium polyacrylate |
| Poly(pyridinium phenylene)-TFSI | Lithium polyacrylate |
| PDADMA-TFSI | Lithium carboxymethyl cellulose |
| PDADMA-FSI | Graphene-carboxylate lithium salt |
| poly(3-vinylimidazolium)-TFSI | Graphene-carboxylate lithium salt |

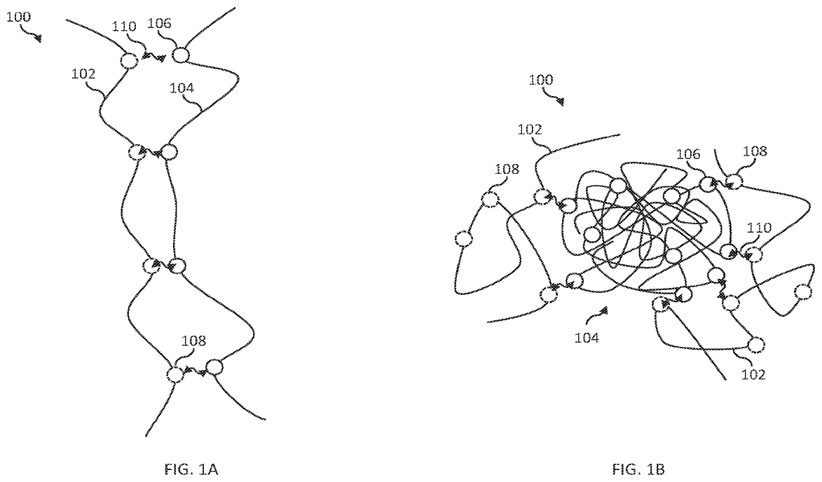

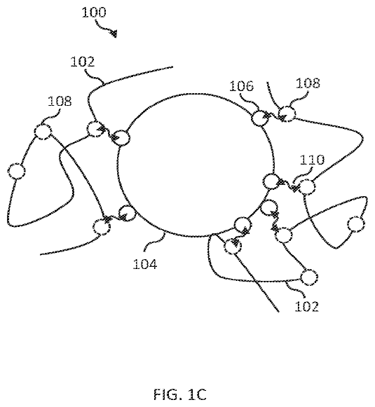

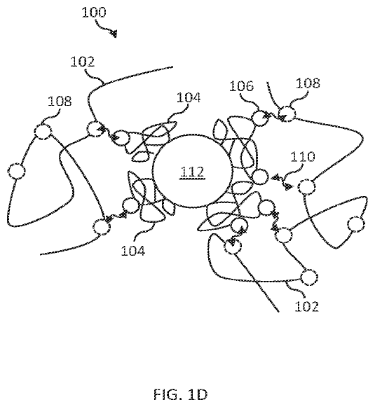

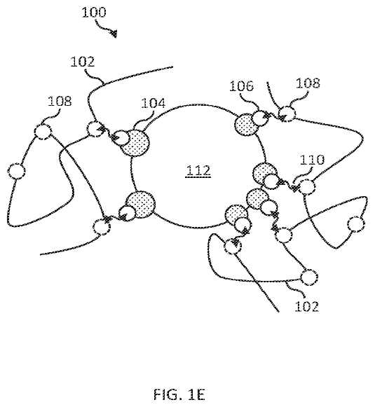

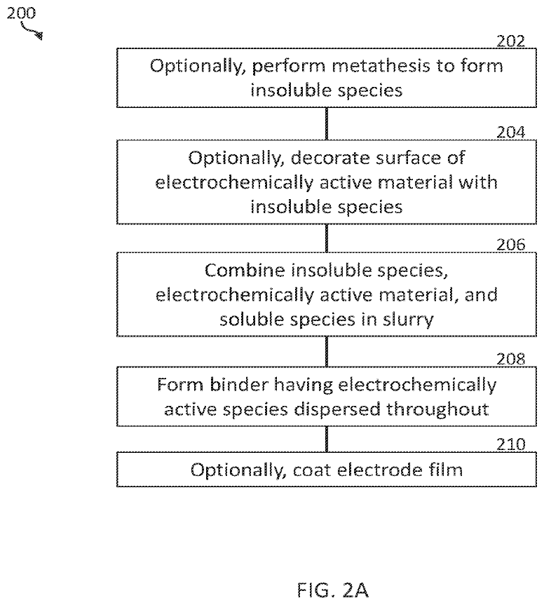

FIG. 1A illustrates an example of a binder 100 formed from a first linear polymer species 102 and second linear polymer species 104. Linear polymer species 102 has numerous representative Lewis base sites labeled 108. Linear polymer species 104 has representative Lewis acid sites labeled 106. Lewis base sites 108 and Lewis acid sites 106 chemically interact, as indicated by arrows 110. If a particular Lewis acid site and particular Lewis base site are too far separated, then no significant interaction will occur between them. Binder 100 may bind together particles of electrochemically active material. For simplicity, electrochemically active material is not shown in FIG. 1A. In a to-scale drawing, such electrochemically active material particles would generally be much larger than the individual polymer chains depicted. Also not shown in FIG. 1A is any electron conducting material, such as conductive carbon, if present. Moreover, only two linear polymer chains are shown, for illustration purposes, but those of skill in the art will recognize that each chain will generally interact with more than one other chain, which can then define a supramolecular network. FIG. 1B illustrates a similar binder 100 to FIG. 1A but with species 102 being a linear polymer and species 104 being a polymer particle. In FIG. 1B, representative Lewis acid sites 106 and Lewis base sites 108 that are not chemically interacting are also shown. FIG. 1C illustrates a similar binder 100 to FIG. 1B but with the particle being a non-polymer particle, for example a silica particle, metal oxide particle, or metal fluoride particle. FIG. 1D illustrates an example where species 104 is a polymer (e.g., a water insoluble polymer) that decorates a surface of particle 112, which may include electrochemically active material or electron conducting material. FIG. 1E illustrates an example where species 104 is a particle (e.g., a water insoluble particle) that decorates a surface of particle 112, which may include electrochemically active material or electron conducting material. In FIGS. 1D-1E, only one particle 112 is shown for simplicity, though generally many such particles will be present. In some embodiments, some particles 112 include electrochemically active material and some particles 112 include electron conducting material.

### Preparation of Electrodes

There are a variety of known methods for manufacturing electrodes for use in a lithium battery (e.g., a lithium-sulfur battery) using an electrode composition. In some embodiments, a slurry-based method is used where a slurry of, for example, a binder and an electrochemically active material [e.g., sulfur or a material comprising sulfur (e.g., a particulate material) (e.g., engineered nanoparticles containing electroactive sulfur compositions)]. In some embodiments, an electron conducting material, such as a conductive carbon is also included in a slurry. In some embodiments, a binder is formed in a slurry from two or more species that are present or introduced into the slurry. These slurries are typically in the form of a viscous liquid that is formulated to facilitate a downstream film formation (e.g., coating) operation. A thorough mixing of a slurry can impact the quality of film formation and efficacy of drying operations, which can affect performance and physical strength of an electrode. Suitable mixing devices include ball mills, magnetic stirrers, sonicators, planetary mixers, high speed mixers, homogenizers, universal type mixers, and static mixers. A liquid used to make a slurry can be one that homogeneously disperses an electrochemically active material, a binder, and any conducting material and additive(s) present, and that is easily evaporated. Suitable slurry liquids include, for example, N-methylpyrrolidone, acetonitrile, methanol, ethanol, propanol, butanol, tetrahydrofuran, water, isopropyl alcohol, dimethylpyrrolidone, gamma butyrolactone, and the like. In some embodiments, a slurry is an aqueous slurry.

In some embodiments, a binder is formed by combining components of the binder together in a slurry. The components may include a species soluble in a solvent for the slurry and a species insoluble in the solvent. The forming of the binder may occur upon chemical interaction of the soluble and insoluble species. Such chemical interaction may occur readily at or near ambient conditions (e.g., in ambient atmosphere and/or at or near room temperature). Such chemical interaction may occur spontaneously upon combining. The soluble species may include Lewis base sites or Lewis acid sites and the insoluble species may include Lewis acid sites or Lewis base sites, respectively, that can then chemically interact with each other. The slurry may be an aqueous slurry. In some embodiments, the soluble species is a polymer, such as a linear polymer. In some embodiments, the insoluble species is a particle or a polymer.

Commonly available precursor materials may not be suitable for forming supramolecular binders. Accordingly, one or more metathesis reactions may be performed to substitute counterions of one or more polymer species to make it/them suitable for use in forming a supramolecular binder. In some embodiments, this involves substituting a counterion to change solubility of a polymer salt in a solvent, for example to change from soluble to insoluble (e.g., in water).

In some embodiments, two metatheses are performed to form a species for use in a binder, for example where substituting to a desirable counterion preferably involves, or requires, more than one substitution and each substitution preferably occurs in different solvents. Examples 1 and 2 below give such an example. Multiple metathesis reactions may be performed to successively reduce mass fraction of a counterion in a species and/or to achieve desired solubility of the species in a certain solvent, such as water or an organic solvent, like acetonitrile. In some embodiments, it is desirable to minimize mass of a counterion of a species in order to be able to produce more binder for a given input mass. Thus, in some embodiments, multiple metatheses are performed where a subsequent counterion (e.g., anion) is lighter than an initially substituted counterion from an earlier metathesis. For example, as in Examples 1 and 2, a first metathesis may substitute a Cl counterion for TFSI to change solubility and a subsequent metathesis may substitute BF₄ for the TFSI (e.g., which may also change the solubility again).

In some embodiments, prior to any combining, an electrochemically active material and/or an electron conducting material (e.g., surface(s) thereof) is decorated with an insoluble species (e.g., polymer or particle species). In that way, a supramolecular network that binds the electrochemically active material and/or electron conducting material may be formed upon combination of the decorated material with a soluble species that chemically interacts with the insoluble species, for example through Lewis acid and base interactions between the species. The decoration may occur during metathesis performed to form the insoluble species. The metathesis may naturally.

Where more than one metathesis is used, electrochemically active material and/or electron conducting material may be added only during a subsequent metathesis, not during an initial metathesis. Certain electrochemically active materials are soluble in certain solvents. Therefore, it is likely not feasible to decorate the material during a first metathesis if the first metathesis uses a solvent in which the material is soluble. However, decoration could be performed during a second metathesis if the second metathesis uses a solvent in which the material is not soluble. For example, certain metal sulfide materials are soluble in water and insoluble in organic solvents, such as acetonitrile. Therefore, those certain metal sulfide materials may be preferably decorated during a second metathesis that is performed in an organic solvent. Electrochemically active carbon sulfur materials may be insoluble in water and therefore not require a second metathesis to decorate. A second metathesis may nonetheless be performed, for example to reduce counterion weight.

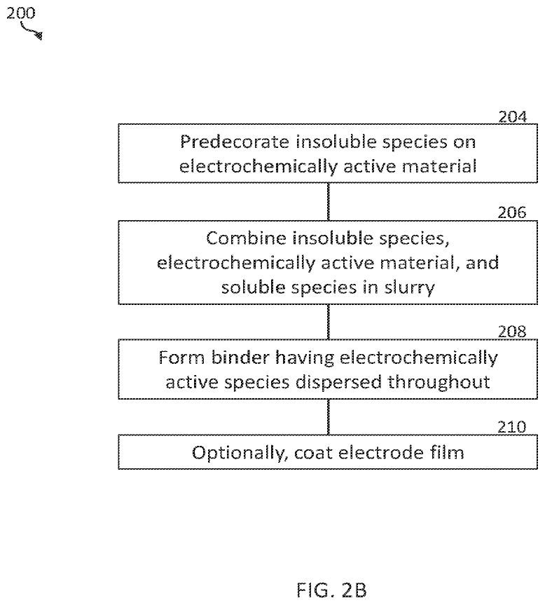

FIGS. 2A-2B illustrate embodiments of method 200 for forming a binder. Referring first specifically to FIG. 2A, optional step 202 includes performing a metathesis to form an insoluble species. Optional step 204 includes decorating a surface of an electrochemically active material with an insoluble species (e.g., formed in optional step 202) (e.g., a cationic polymer salt). Such decoration may occur during a metathesis reaction. In step 206, an insoluble species, an electrochemically active material, and a soluble species (e.g., an anionic polymer salt) are combined in a slurry. In step 208, a binder having the electrochemically active species dispersed throughout is formed. The forming may occur spontaneously (e.g., upon addition of a soluble species to a mixture of electrochemically active material and insoluble species or upon addition of electrochemically active material and insoluble species to a solution of a soluble species). In optional step 210, an electrode film comprising the binder and electrochemically active material is coated, for example on a current collector.

FIG. 2B illustrates an embodiments of method 200 that uses pre-decoration. In embodiments of method 200 according to FIG. 2B, an insoluble species (e.g., insoluble particle species) is pre-decorated on an electrochemically active material. In step 206, the insoluble species, the electrochemically active material, and a soluble species are combined in a slurry. In step 208, a binder having the electrochemically active species dispersed throughout is formed. The forming may occur spontaneously (e.g., upon addition of a soluble species to a mixture of electrochemically active material and insoluble species or upon addition of electrochemically active material and insoluble species to a solution of a soluble species). In optional step 210, an electrode film comprising the binder and electrochemically active material is coated, for example on a current collector.

In some embodiments, a prepared composition is coated onto a current collector and dried to form an electrode. Specifically, a slurry is used to coat an electrical conductor to form an electrode by evenly spreading a slurry on to a conductor (e.g., a current collector), which is then, in certain embodiments, roll-pressed (e.g., calendered) and/or heated. Generally, a matrix of an electrochemically active material, and conductive material if present, are held together and on a conductor by a binder. In certain embodiments, carbon particles, carbon nanofibers, carbon nanotubes, are dispersed in a matrix to improve electrical conductivity. Examples of conductive carbon include powders, such as carbon black, Super PR, C-NERGY™ Super C65, Ensaco® black, Ketjenblack®, acetylene black, synthetic graphite such as Timrex® SFG-6, Timrex® SFG-15, Timrex® SFG-44, Timrex® KS-6, Timrex® KS-15, Timrex® KS-44, natural flake graphite, carbon nanotubes, fullerenes, hard carbon, and/or mesocarbon microbeads. Alternatively or additionally, in certain embodiments, lithium ions (e.g., provided in salt form) are dispersed in a matrix to improve lithium ion conductivity.

In certain embodiments, a current collector is selected from the group consisting of: aluminum foil, copper foil, nickel foil, stainless steel foil, titanium foil, zirconium foil, molybdenum foil, nickel foam, copper foam, carbon paper, carbon, fiber sheets, polymer substrates coated with conductive metal, and/or combinations thereof. Meshes of these metals may also be used in a current collector. Alternatively or additionally, 3D structured current collectors may be used.

### Electrochemical Cells Including Binders

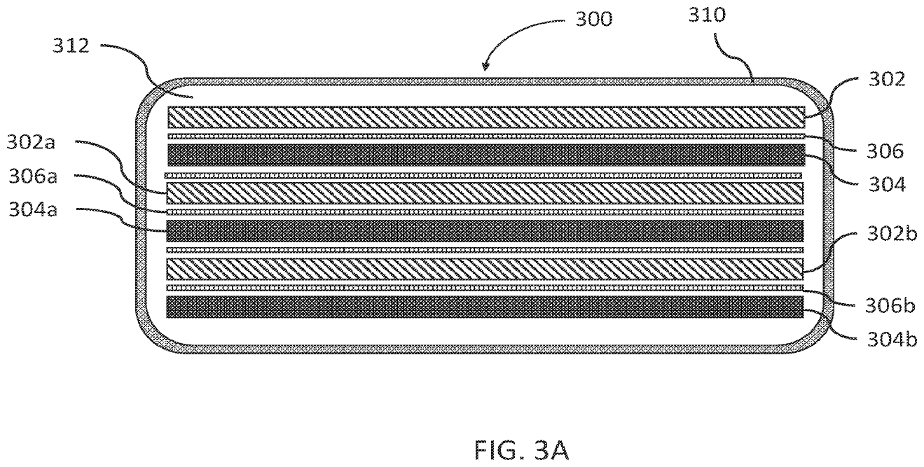

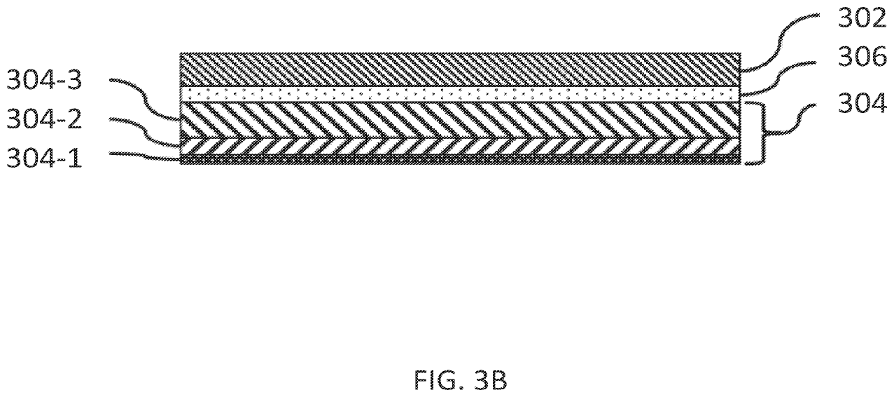

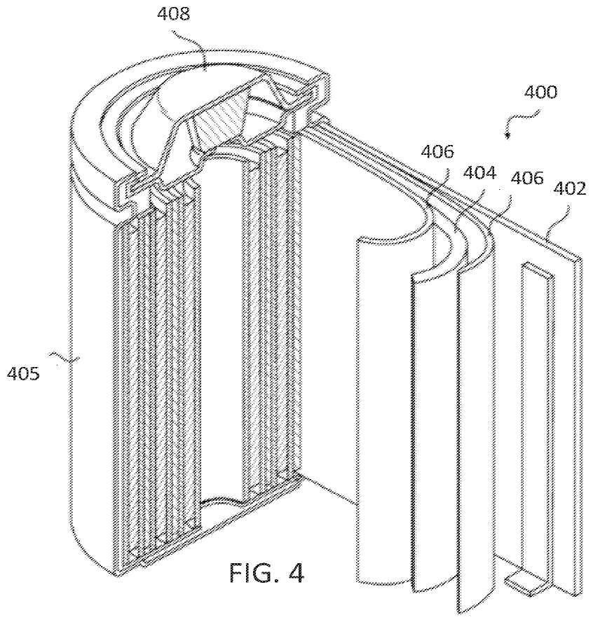

In some embodiments, a binder disclosed herein is used with (e.g., within) one or more electrodes of an electrochemical cell, for example a cathode, an anode, or both a cathode and an anode. A binder may bind electrochemically active material together (e.g., particles containing (e.g., composed of) electrochemically active material). In some embodiments a binder (e.g., also) serves to bind conductive carbon in a composition if present. An electrochemical cell may be a battery, such as a secondary battery. A cathode included in a battery may be a conversion cathode, including electrochemically active conversion material, such as in a lithium-sulfur battery or sodium-sulfur battery. In some embodiments, a lithium-sulfur battery of the present disclosure includes a lithium anode, a sulfur-based cathode, and an electrolyte permitting (e.g., lithium) ion transport between the anode and the cathode. In certain embodiments, a battery includes a casing (e.g., a hard or soft casing), which encloses an anode, cathode, separator, and electrolyte. In certain embodiments, a battery case includes an electrically conductive anodic-end cover or tab in electrical communication with an anode, and an electrically conductive cathodic-end cover or tab in electrical communication with a cathode to facilitate charging and discharging via an external circuit. Various cell constructions may be used, such as, for example, cylindrical cells, coin cells, or pouch cells. FIGS. 3A-4 illustrate exemplary electrochemical cells that include a binder disclosed herein (e.g., used with one or more electrodes, such as an anode or a cathode or both).

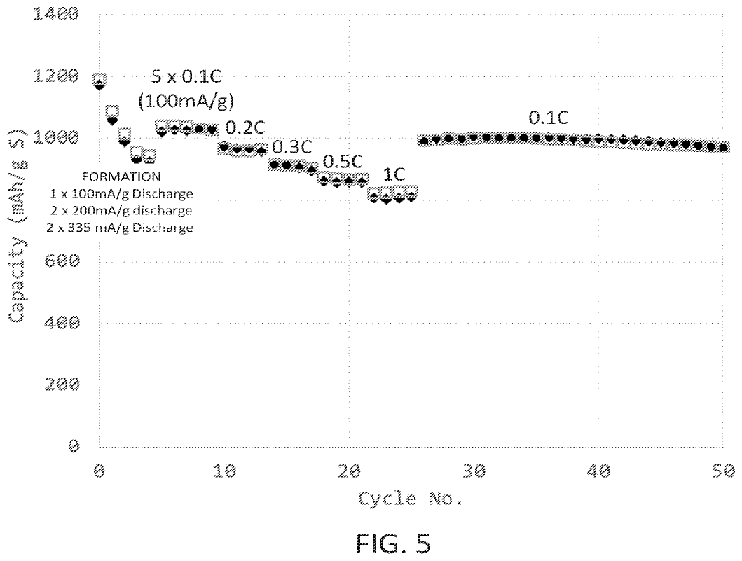

FIG. 3A illustrates a cross section of an electrochemical cell 300 in accordance with exemplary embodiments of the disclosure. Electrochemical cell 300 includes a negative electrode 302, a positive electrode 304, a separator 306 interposed between negative electrode 302 and positive electrode 304, a container 510, and a fluid electrolyte 512 in contact with negative and positive electrodes 302, and 304 respectively. Such cells optionally include additional layers of electrode and separators 302a, 302b, 304a, 304b, 306a, and 306b. FIG. 5 illustrates another view of a cross section through a representative cell stack showing the negative electrode 302, a positive electrode 304, and a separator 306 interposed between the negative electrode 302 and positive electrode 304. FIG. 3B also shows the layers including the electrode 304. Specifically, the layers include current collector 304-1, cathode layer 304-2 including a lithium intercalation electrochemically active material and cathode layer 304-3 including a conversion electrochemically active material. As shown, the lithium intercalation electrochemically active material 304-2 is interposed between current collector 304-1 and cathode layer 304-3.

Negative electrode 302 (also sometimes referred to herein as an anode) includes a negative electrode electrochemically active material that can accept cations. Non-limiting examples of negative electrode electrochemically active materials for lithium-based electrochemical cells include Li metal, Li alloys such as those of Si, Sn, Bi, In, and/or Al alloys, Li₄Ti₅O₁₂, hard carbon, graphitic carbon, metal chalcogenides, and/or amorphous carbon. In accordance with some embodiments of the disclosure, most (e.g., greater than 90 wt %) of an anode electrochemically active material can be initially included in a discharged positive electrode 304 (also sometimes referred to herein as a cathode) when electrochemical cell 300 is initially made, so that an electrode electrochemically active material forms part of first electrode 302 during a first charge of electrochemical cell 300.

A technique for depositing electrochemically active material on a portion of negative electrode 302 is described in U.S. Patent Publication No. 2016/0172660 and similarly in U.S. Patent Publication No. 2016/0172661, the contents of each of which are hereby incorporated herein by reference, to the extent such contents do not conflict with the present disclosure.

Negative electrode 302 and positive electrode 304 can further include one or more electronically conductive additives as described herein. In accordance with some embodiments of the disclosure, negative electrode 302 and/or positive electrode 304 further include one or more polymer binders as described below.

FIG. 4 illustrates an example of a battery according to various embodiments described below. A cylindrical battery is shown here for illustration purposes, but other types of arrangements, including prismatic or pouch (laminate-type) batteries, may also be used as desired. Example Li battery 400 includes a negative anode 402, a positive cathode 404, a separator 406 interposed between the anode 402 and the cathode 404, an electrolyte (not shown) impregnating the separator 406, a battery case 405, and a sealing member 408 sealing the battery case 405. It will be appreciated that example battery 400 may simultaneously embody multiple aspects of the present disclosure in various designs.

The present disclosure provides, inter alia, secondary batteries including an electrode (e.g., cathode) made using a composition described herein, for example including a binder disclosed herein. Such secondary batteries include, for example, lithium-based batteries, such as lithium-ion batteries and lithium-sulfur batteries, as well as other batteries, such as sodium-sulfur batteries. In certain embodiments, such batteries include a lithium-containing anode composition coupled to the provided cathode composition by a lithium conducting electrolyte. In some embodiments, such batteries also include additional components such as separators between the anode and cathode, anodic and cathodic current collectors, terminals by which a cell can be coupled to an external load, and packaging such as a flexible pouch or a rigid metal container. In some embodiments, a lithium-sulfur battery including a sulfur-containing cathode that includes a binder disclosed herein, a lithium-containing anode, and an electrolyte ionically coupling the anode and cathode. In some embodiments, a binder disclosed herein is used in an electrode that is included in an electrochemical cell that is not a battery, for example a fuel cell. Moreover, a battery need not be a secondary battery. In some embodiments, a binder is included in an electrode of a primary battery.

### Anodes

In certain embodiments, an electrochemical cell includes an anode. For example, a lithium battery (e.g., a lithium-sulfur battery) may include a lithium anode. In some embodiments, any lithium anode suitable for use in lithium-sulfur cells may be used. In certain embodiments, an anode of a lithium-sulfur battery includes a negative electrochemically active material selected from materials in which lithium intercalation reversibly occurs, materials that react with lithium ions to form a lithium-containing compound, metallic lithium, lithium alloys, and combinations thereof. In certain embodiments, an anode includes metallic lithium. In certain embodiments, lithium-containing anodic compositions include carbon-based compounds. In certain embodiments, a carbon-based compound is selected from the group consisting of crystalline carbon, amorphous carbon, graphite, and mixtures thereof. In certain embodiments, a material that reacts with lithium ions to form a lithium-containing compound is selected from the group consisting of tin oxide (SnO₂), titanium nitrate, and silicon. In certain embodiments, a lithium alloy includes an alloy of lithium with another alkali metal (e.g., sodium, potassium, rubidium or cesium). In certain embodiments, a lithium alloy includes an alloy of lithium with a transition metal. In certain embodiments, lithium alloys include alloys of lithium and a metal selected from the group consisting of Na, K, Rb, Cs, Fr, Be, Mg, Ca, Sr, Ba, Ra, Al, Sn, and combinations thereof. In certain embodiments, a lithium alloy includes an alloy of lithium with indium. In certain embodiments, an anode includes a lithium-silicon alloy. Examples of suitable lithium-silicon alloys include: Li₁₅Si₄, Li₁₂Si₇, Li₇Si₃, Li₁₃Si₄, and Li₂₁Si₅/Li₂₂Si₅. In certain embodiments, a lithium metal or lithium alloy is present as a composite with another material. In certain embodiments, such composites include materials such as graphite, graphene, metal sulfides or oxides, or conductive polymers.

An anode may be protected against redox shuttling reactions and hazardous runaway reactions by any of the methodologies reported in the art, for example, by creating a protective layer on a surface of an anode by chemical passivation or polymerization. For example, in certain embodiments, an anode includes an inorganic protective layer, an organic protective layer, or a mixture thereof, on a surface of lithium metal. In certain embodiments, an inorganic protective layer includes C, Ag, Sb, Mg, Al, Bi, Sn, Pb, Cd, Si, In, Ga, Li₇La₃Zr₂O₁₂ (LLZO, garnet), Li₁₊ₓAlₓGe₂₋ₓ(PO₄)₃ (LAGP), LiPON, Li₁₊ₓAlₓTi₂(PO₄)₃ (LATP), lithium silicate, lithium borate, lithium phosphate, lithium phosphoronitride, lithium silicosulfide, lithium borosulfide, lithium aluminosulfide, lithium phosphosulfide, lithium fluoride or combinations thereof. In certain embodiments, an organic protective layer includes a conductive monomer, oligomer, or polymer selected from poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-di-yl), or combinations thereof.

Moreover, in certain embodiments, inactive sulfur material, generated from an electroactive sulfur material of a cathode, during charging and discharging of a lithium-sulfur battery, attaches to an anode surface. The term “inactive sulfur”, as used herein, refers to sulfur that has no activity upon repeated electrochemical and chemical reactions, such that it cannot participate in an electrochemical reaction of a cathode. In certain embodiments, inactive sulfur on an anode surface acts as a protective layer on such electrode. In certain embodiments, inactive sulfur is lithium sulfide.

Anode-free (e.g., anode-less) configurations are also contemplated. In an anode-free configuration, a current collector is provided in place of an anode and an electrochemically active species, such as lithium in a lithium-sulfur battery, is deposited on a surface of the current collector during a first electrochemical cycle (or first few electrochemical cycles). Such lithium may be derived from an electrolyte and/or one or more additives in the electrochemical cell. The surface of the current collector then acts as a lithium source during further electrochemical cycling.

It is further contemplated that the present disclosure can be adapted for use in sodium-sulfur batteries. Such sodium-sulfur batteries include a sodium-based anode, and are encompassed within the scope of present disclosure.

### Cathodes

In certain embodiments, an electrochemical cell includes a cathode. A cathode generally includes an electrochemically active material and a binder. In some embodiments, a cathode further includes an electron conducting material, such as a conductive carbon. Certain compositions disclosed herein would be adhered to a current collector to form cathodes for electrochemical cells, such as batteries. In some embodiments, a cathode is “carbon-free” (including relatively carbon free, e.g., no greater than 10 wt. %, no greater than 5 wt. % carbon, no greater than 4 wt. % carbon, no greater than 3 wt. % carbon, no greater than 2 wt. % carbon, no greater than 1 wt. % carbon, or no greater than 0.5 wt. % carbon, for example). In some embodiments, a cathode includes a conductive carbon. A cathode may comprise one or more additives. For example, in certain embodiments, provided cathode compositions may comprise 3D structured graphene (e.g., as described in U.S. Pat. No. 11,299,397). In certain embodiments, provided compositions have satisfactory electrical conductivity to provide a cathode with a low resistance pathway for electrons to access such manufactured cathode. In various embodiments, other additives are included in the composition to alter or otherwise enhance a cathode produced according to the principles described herein. Other cathode components include, for example, a current collector, connecting tabs, and the like.

In certain embodiments, a cathode (electrode) composition includes a non-carbon electrochemically active material (e.g., an intercalation material) and/or a sulfur electrochemically active material. A sulfur-based electrochemically active material may include sulfur in its S& cyclic molecular form, in the form of lithium sulfide (e.g., Li₂S₂ and/or Li₂S), or in the form of an electroactive organosulfur compound or an electroactive sulfur containing polymer, or a combination thereof. In certain embodiments, an electrochemically active material is an intercalation material structured to intercalate lithium ions. In certain embodiments, an electrochemically active material operates in a voltage range overlapping with the discharge voltage range of S₈→Li₂S (sulfur to lithium sulfide conversion), e.g., from about 1.8V to about 2.6V vs. Li/Li⁺, e.g., from about 2.0V to about 2.4V vs. Li/Li⁺.

In certain embodiments, an electrochemically active material comprises a combination of a sulfur electroactive material (e.g., elemental sulfur, LiS2, organo-sulfur compounds or polymers) with one or more metal sulfides. In certain embodiments, the one or more metal sulfudes comprises one or more of the following: TiS₂, LiTiS₂ (LTS), MoS₂, Mo₆S₈, VS₂, TaS₂, NbSe₃, or mixtures of any two or more of these. In certain embodiments, an electrochemically active material comprises a combination of sulfur and TiS₂. In certain embodiments, an electrochemically active material comprises a combination of lithium sulfide and TiS₂. In certain embodiments, an electrochemically active material comprises a combination of sulfur and VS₂. In certain embodiments, an electrochemically active material comprises a combination of lithium sulfide and VS₂. In certain embodiments, an electrochemically active material comprises a combination of sulfur and Mo₆S₈. In certain embodiments, an electrochemically active material comprises a combination of lithium sulfide and Mo₆S₈. In certain embodiments, where the electrochemically active material comprises a mixture of sulfur and a metal sulfide, the mixture has sulfur:metal sulfide ratio between about 1:5 and about 10:1. In certain embodiments, where the electrochemically active material comprises a mixture of sulfur and a metal sulfide, the mixture has sulfur:metal sulfide ratio in a range of 1:5 to 10:1, for example of about 1:5, about 1:2, about 1:1, about 2:1, about 3:1, about 5:1 or about 10:1.

In certain embodiments, an electrochemically active material comprises one or more chalcogenides. In certain embodiments, a chalcogenide has at least one chalcogen anion (oxygen, sulfur, selenium, tellurium, or polonium anion) and at least one electropositive element. In certain embodiments, the one or more chalcogenides may be sulfide-, selenide-, or telluride-based. In certain embodiments, the one or more chalcogenides comprises a metal sulfide. In certain embodiments, the one or more chalcogenides comprises one or more of the following: TiS₃, LiTiS₂ (LTS), MoS₂, Mo₆S₈, VS₂, TaS₂, and NbSe₃. In certain embodiments, the one or more chalcogenides comprises a transition metal oxide and/or a polyanion compound. In certain embodiments, the one or more chalcogenides comprises a metal monochalcogenide having the formula MX where M is a transition metal and X is S, Se, or Te. In certain embodiments, the one or more chalcogenides comprises at least one transition metal dichalcogenide (TMD) of the formula MX₂, where M is a transition metal (e.g., Ti, V, Co, Ni, Zr, Nb, Mo, V, Tc, Rh, Pd, Hf, Ta, W, Re, Ir, or Pt) and where X is S, Se, or Te. In certain embodiments, the one or more chalcogenides comprises a lithiated material with a layered crystal structure (e.g., TiS₂, CoO₂, NiO₂, MnO₂, Ni_{0.33}Mn_{0.33}Co_{0.33}O₂, Ni_{0.8}Co_{0.15}Al_{0.05}O₂, or MnO₃), a material with a spinel crystal structure (e.g., Mn₂O₄ or Co₂O₄), a material with an olivine crystal structure (e.g., FePO₄, MnPO₄, or CoPO₄), and/or a material with a tavorite crystal structure (e.g., FeSO₄F or VPO₄F). In certain embodiments, the one or more chalcogenides comprises a lithiated derivative of a material with a layered crystal structure (e.g., LiTiS₂, LiCoO₂, LiNiO₂, LiMnO₂, LiNi_{0.33}Mn_{0.33}Co_{0.33}O₂, LiNi_{0.8}Co_{0.15}Al_{0.05}O₂, or Li₂MnO₃), a lithiated derivative of a material with a spinel crystal structure (e.g., LiMn₂O₄ or LiCo₂O₄), lithiated derivative of a material with an olivine crystal structure (e.g., LiFePO₄, LiMnPO₄, or LiCoPO₄), and/or a lithiated derivative of a material with a tavorite crystal structure (e.g., LiFeSO₄F or LiVPO₄F).

In certain embodiments, one or more non-carbon, non-sulfur electrochemically active materials are characterized in that they have high electronic conductivity. For example, the non-carbon, non-sulfur electrochemically active material(s) may have a conductivity greater than about 10⁻³ mS/cm²; greater than about 0.01 mS/cm², greater than about 0.05 mS/cm², greater than 0.1 mS/cm², greater than 0.5 mS/cm², or greater than about 1 mS/cm².

In certain embodiments, the cathode composition contains conductive material and a binder. In certain embodiments, a conductive material comprises an electrically conductive material that facilitates movement of electrons within a composite. For example, in certain embodiments, a conductive material is selected from the group consisting of carbon-based materials, graphite-based materials, conductive polymers, metals, semiconductors, metal oxides, metal sulfides, and combinations thereof, where non-carbon materials are preferred.

In certain embodiments, a cathode further comprises a coating layer. For example, in certain embodiments, a coating layer comprises a polymer, an organic material, an inorganic material, or a mixture thereof that is not an integral part of the porous composite or the current collector.

In certain embodiments, a cathode comprises one or more of the following features: (a) a “stack” of multi-functional materials (e.g., wherein the stack comprises, for example, particles with gradient structures that balance the transport of ions and electrons for improved power capability, energy density, and life; bi-functional cathode additives that simultaneously store Li and conduct electrons, replacing expensive and space-wasting carbons; a binding molecule that spatially constrains the electrochemical reaction storing the energy and thereby extends life; electrolyte components that improve the basic efficiency of the electrolyte, providing improved energy density; and/or a cathode design that enables greater safety and energy density); (b) a tight electrode layer; (c) a tight tertiary structure; (d) porosity control; (e) a core-shell structure; (f) a cross-linked polymer shell; (g) a self-doped polymer shell; (h) an ion conductive binder; (i) a dual layer hybrid cathode; (j) a polymer that traps polysulfide; (k) a three-dimensional structure with high surface area (e.g., to hold both carbon and lithium, e.g., to intercalate); and (l) a three-dimensional structure within which carbon is replaced with a metal disulfide (e.g., and wherein the battery comprises a polymer electrolyte for sulfur).

### Separators

In certain embodiments, an electrochemical cell (e.g., lithium-sulfur battery) includes a separator, which physically separates an anode and cathode. In certain embodiments, a separator is an impermeable material substantially, or completely, impermeable to electrolyte. In certain embodiments, a separator is impermeable to polysulfide ions dissolved in electrolyte. In certain embodiments, a separator as a whole is impermeable to electrolyte, such that passage of electrolyte-soluble sulfides is blocked. In some embodiments, a degree of ionic conductivity across a separator is provided, for example via apertures in such separator. In certain such embodiments, a separator as a whole inhibits or restricts passage of electrolyte-soluble sulfides between anodic and cathodic portions of a battery as a result of its impermeability. In certain embodiments, a separator of impermeable material is configured to allow lithium ion transport between anode and cathode of a battery during charging and discharging of a cell. In some such embodiments, a separator does not completely isolate an anode and a cathode from each other. One or more electrolyte-permeable channels bypassing, or penetrating through apertures in, an impermeable face of a separator should be provided to allow sufficient lithium ion flux between anodic and cathodic portions of a battery. In some embodiments, where a separator is itself completely impermeable, a channel is provided through an annulus between a periphery of a separator and walls of a battery case.

It will be appreciated by a person skilled in the art that optimal dimensions of a separator should balance competing imperatives: maximum impedance to polysulfide migration while allowing sufficient lithium ion flux. Aside from this consideration, shape and orientation of a separator is not particularly limited, and depends in part on battery configuration. For example, a separator may be substantially circular in a coin-type cell, and substantially rectangular in a pouch-type cell. As described herein, a surface of a separator may be devoid of apertures, so that lithium ion flux occurs exclusively around edges of an impermeable sheet. However, certain embodiments are also contemplated in which some or all of a required lithium ion flux is provided through apertures in a separator. In some embodiments, a separator is substantially flat. However, it is not excluded that curved or other non-planar configurations may be used.

A separator may be of any suitable thickness. To maximize energy density of a battery, it is generally preferred that a separator is as thin and light as possible. However, a separator should be thick enough to provide sufficient mechanical robustness and to ensure suitable impermeability. In certain embodiments, a separator has a thickness of from about 1 micron to about 200 microns, preferably from about 5 microns to about 100 microns, more preferably from about 10 microns to about 30 microns.

### Electrolytes

In certain embodiments, a lithium-sulfur battery includes an electrolyte including an electrolytic salt. Examples of electrolytic salts include, for example, lithium bis(trifluoromethanesulfonyl)imide, lithium triflate, lithium perchlorate, LiPF₆, Lithium bis(fluoro) sulfonylimide (LiFSI), lithium iodide, lithium nitrate, LiBF₄, tetraalkylammonium salts (e.g., tetrabutylammonium tetrafluoroborate, TBABF₄), liquid state salts at room temperature (e.g., imidazolium salts, such as 1-ethyl-3-methylimidazolium bis-(perfluoroethyl sulfonyl)imide, EMIBeti), and the like.

In certain embodiments, an electrolyte includes one or more alkali metal salts. In certain embodiments, such salts include lithium salts, such as LiCF₃SO₃, LiClO₄, LiNO₃, LiPF₆, LiFSI, LiI, LiBF₄, and lithium bis(trifluoromethanesulfonyl)imide (LiTFSI), or combinations thereof. In certain embodiments, an electrolyte includes ionic liquids, such as 1-ethyl-3-methylimidzaolium-TFSI, N-butyl-N-methyl-piperidinium-TFSI, N-methyl-n-butyl pyrrolidinium-TFSI, N-methyl-N-propylpiperidinium-TFSI, 1-ethyl-3-methylimidzaolium-FSI, N-butyl-N-methyl-piperidinium-FSI, N-methyl-n-butyl pyrrolidinium-FSI, N-methyl-N-propylpiperidinium-FSI, 1-ethyl-3-methylimidzaolium-PF₆, N-butyl-N-methyl-piperidinium-PF₆, N-methyl-n-butyl pyrrolidinium-PF₆, N-methyl-N-propylpiperidinium-PF₆, 1-ethyl-3-methylimidzaolium-iodide, N-butyl-N-methyl-piperidinium-iodide, N-methyl-n-butyl pyrrolidinium-iodide, N-methyl-N-propylpiperidinium-iodide, or combinations thereof. In certain embodiments, an electrolyte includes superionic conductors, such as sulfides, selenides, oxides, phosphides, and phosphates, for example, phosphorous pentasulfide, or combinations thereof.

In certain embodiments, an electrolyte is a liquid. For example, in certain embodiments, an electrolyte includes an organic solvent. In certain embodiments, an electrolyte includes only one organic solvent. In some embodiments, an electrolyte includes a mixture of two or more organic solvents. In certain embodiments, a mixture of organic solvents includes organic solvents from at least two groups selected from weak polar solvent groups, strong polar solvent groups, and lithium protection solvents.

The term “weak polar solvent,” as used herein, is defined as a solvent that is capable of dissolving elemental sulfur and has a dielectric coefficient of less than 15. In some embodiments, a weak polar solvent is selected from aryl compounds, bicyclic ethers, and acyclic carbonate compounds. Non-limiting examples of weak polar solvents include xylene, dimethoxyethane, 2-methyltetrahydrofuran, diethyl carbonate, dimethyl carbonate, toluene, dimethyl ether, diethyl ether, diglyme, tetraglyme, and the like. The term “strong polar solvent,” as used herein, is defined as a solvent that is capable of dissolving lithium polysulfide and has a dielectric coefficient of more than 15. In some embodiments, a strong polar solvent is selected from bicyclic carbonate compounds, sulfoxide compounds, lactone compounds, ketone compounds, ester compounds, sulfate compounds, and sulfite compounds. Non-limiting examples of strong polar solvents include hexamethyl phosphoric triamide, γ-butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, ethylene glycol sulfite, and the like. The term “lithium protection solvent”, as used herein, is defined as a solvent that forms a good protective layer, i.e. a stable solid-electrolyte interface (SEI) layer, on a lithium surface, and which shows a cyclic efficiency of at least 50%. In some embodiments, a lithium protection solvent is selected from saturated ether compounds, unsaturated ether compounds, and heterocyclic compounds including one or more heteroatoms selected from the group consisting of N, O, and/or S. Non-limiting examples of lithium protection solvents include tetrahydrofuran, 1,3-dioxolane, 3,5-dimethylisoxazole, 2,5-dimethyl furan, furan, 2-methyl furan, 1,4-oxane, 4-methyldioxolane, and the like.

In certain embodiments, an electrolyte is a liquid (e.g., an organic solvent). In some embodiments, a liquid is selected from the group consisting of organocarbonates, ethers, sulfones, water, alcohols, fluorocarbons, or combinations of any of these. In certain embodiments, an electrolyte includes an ethereal solvent.

In certain embodiments, an organic solvent includes an ether. In certain embodiments, an organic solvent is selected from the group consisting of 1,3-dioxolane, dimethoxyethane, diglyme, triglyme, γ-butyrolactone, γ-valerolactone, and combinations thereof. In certain embodiments, an organic solvent includes a mixture of 1,3-dioxolane and dimethoxyethane. In certain embodiments, an organic solvent includes a 1:1 v/v mixture of 1,3-dioxolane and dimethoxyethane. In certain embodiments, an organic solvent is selected from the group consisting of: diglyme, triglyme, γ-butyrolactone, γ-valerolactone, and combinations thereof. In certain embodiments, an electrolyte includes sulfolane, sulfolene, dimethyl sulfone, or methyl ethyl sulfone. In some embodiments, an electrolyte includes ethylene carbonate, propylene carbonate, dimethyl carbonate, diethyl carbonate, or methylethyl carbonate.

In certain embodiments, an electrolyte includes a liquid (e.g., an organic solvent). In some embodiments, a liquid is selected from the group consisting of organocarbonates, ethers, sulfones, water, alcohols, fluorocarbons, or combinations of any of these. In certain embodiments, an electrolyte includes an ethereal solvent. In certain embodiments, an electrolyte includes a liquid selected from the group consisting of sulfolane, sulfolene, dimethyl sulfone, and methyl ethyl sulfone. In certain embodiments, an electrolyte includes a liquid selected from the group consisting of ethylene carbonate, propylene carbonate, dimethyl carbonate, diethyl carbonate, and methylethyl carbonate.

In certain embodiments, an electrolyte is a solid. In certain embodiments, a solid electrolyte includes a polymer. In certain embodiments, a solid electrolyte includes a glass, a ceramic, an inorganic composite, or combinations thereof. In certain embodiments, a solid electrolyte includes a polymer composite with a glass, a ceramic, an inorganic composite, or combinations thereof. In certain embodiments, such solid electrolytes include one or more liquid components as plasticizers or to form a “gel electrolyte.”

### Other Uses

The foregoing explanation focused on using binders in the context of electrodes for electrochemical cells. However, use of binders disclosed herein is not so limited. For example, binders may be used to bind other particles or non-particulate material together. Embodiments analogous to those expressly described above where electrochemically active material is instead some other, otherwise equivalent material are also contemplated. In some embodiments, a binder disclosed herein is used in a composite to bind a material. The material may be in particulate form, for example having the form of flakes, rods, tubes, or spherical particles. The material may be nanoparticulate. The composite may be a film. The film may be self-supporting or a coating on a substrate.

### EXAMPLES

In order that the application may be more fully understood, the following examples are set forth. It should be understood that these examples are for illustrative purposes only and are not to be construed as limiting in any manner.

### Example 1: Preparation of PDADMA-TFSI Polymer

This example describes synthesis of a species that can be used in a binder. The species in this case is a water-insoluble cationic polymer in the form of a salt. To start, 30 g of a 20 wt. % solution of poly(diallyldimethylammonium chloride) (PDADMAC) (400-500K molecular weight (g/mol)) in water was diluted with an additional 150 mL of DI water in a beaker and stirred until homogeneous. In a separate beaker, 12.82 g lithium bis(trifluoromethanesulfonylimide) (LiTFSI) was dissolved in 20 mL DI water, then poured into the polymer solution over about 5 min while stirring with a magnetic stir bar at 800 rpm. A white precipitate formed immediately, accompanied by an increase in viscosity of the mixture, indicating occurrence of metathesis to replace the chloride with TFSI. After addition, the mixture was stirred at room temperature at 500 rpm overnight with the beaker covered in aluminum foil to prevent splattering and evaporation. The mixture was then filtered through filter paper on a ceramic filter and filtration flask and washed with 1 L de-ionized water. Additional air was pulled over the white product to dry it until loose particles formed. The product was then dried at 65° C. overnight, then again at 115° C. overnight. Ultimately, 13 g of off-white solid PDADMA-TFSI product was obtained.

### Example 2: Preparation of Sulfur-Metal Sulfide (SMS)/PDADMA-BF₄ Polymer Composite

This example describes synthesis of a species that can be used in a binder. The polymer particle species in this case is a water-insoluble and acetonitrile-insoluble cationic polymer in the form of a salt. To start, 1.193 g of poly(diallyldimethylammonium) bis(trifluoromethanesulfonyl)imide (PDADMA-TFSI) polymer was dissolved in 50 mL of anhydrous acetonitrile in a 500 mL polypropylene centrifuge tube inside a humidity-controlled dry room. Then, 9.375 g of a sulfur-titanium disulfide (SMS) physical mixture (70:30 weight ratio S:TiS₂) was added, as a black solid, in portions, followed by an additional 50 mL anhydrous acetonitrile. The centrifuge tube was sealed and mixed by sonication for 10 min followed by stirring with a magnetic stir bar for 10 min. In a separate beaker, 2.5 g of lithium tetrafluoroborate (LiBF₄) was dissolved in 20 mL anhydrous acetonitrile, and half of the resulting solution was added to the mixture (including the polymer-SMS) in the centrifuge tube dropwise. The reaction was mixed by sonication for 10 min followed by stirring for 10 min. The rest of the LiBF₄ solution was added and mixed in the same manner, and the reaction vessel was sealed and stirred at room temperature overnight. The mixture was centrifuged at 8000 rpm for 20 min and the clear supernatant decanted off and discarded. Then, 100 mL anhydrous acetonitrile was added to the remaining black solid and mixed by sonication for 10 min followed by stirring for 10 min. The centrifugation was repeated and the clear supernatant decanted off and discarded. The black solid product was dried overnight at 65° C. in a vacuum oven. Ultimately, 6 g of PDADMA-BF₄ product was obtained. Without wishing to be bound by any particular theory, based on the black appearance of the product, the SMS was dispersed in the PDADMA-BF₄ product with the PDADMA-BF₄ decorating the SMS.

### Example 3: Preparation of Carbon Sulfur Electroactive Material/PDADMAT Composite

This example describes a synthesis and testing of a cathode using a binder. A substantively similar procedure to examples 1 and 2 was followed to construct a carbon sulfur electrochemically active material decorated with PDADMAT via suspending the active material in water and precipitation of PDADMAT. A cathode was then formed from an aqueous-alcohol slurry with the PDADMAT-decorated active material and tested. Capacity of the resulting cathode was tested using a “rate ladder” procedure, the results of which are plotted in FIG. 5.

### Example 4: Preparation of Cathodes with a “Supramolecular” Binders

### Example 4a Preparation of a Sulfur Metal-Sulfide Cathode with Supramolecular Binder (Sulfur Metal-Sulfide×PDADMA-TFSI/Sodium Polyacrylate)

A mixture of 1-propanol, an aqueous solution containing sodium polyacrylate (PAA-Na), and conductive carbon was mixed in a FlackTek SpeedMixer™ to form a slurry. Acetonitrile and a powder composed of 70% sulfur and 30% TiS₂ by weight were added at intervals until the desired mass fraction of electroactive material was present. A specified mass fraction of polydiallyldimethyl ammonium bis(trifluoromethanesulfonyl)imide powder was then added to along with additional acetonitrile. The slurry was thoroughly mixed and cast onto carbon coated aluminum foil to form a cathode film. The cathode was dried under ambient conditions for two hours, and then placed in a vacuum oven at 60° C. overnight. Resulting cathode films had a final total solids loading of 8.3 to 9.3 mg/cm².

### Example 4b: Preparation of a Carbon-Sulfur Composite Cathode with Supramolecular Binder (CMD, PDADMA-TFSI/Sodium Polyacrylate)

A mixture of 1-propanol, an aqueous solution of PAA-Na, and conductive carbon was mixed in a FlackTek SpeedMixer™ to form a slurry. Acetonitrile and powder composed of 80% sulfur and 20% carbon was added at intervals. A measured amount of polydiallyldimethyl ammonium bis(trifluoromethanesulfonyl)imide powder was then added to achieve the desire mass fraction along with additional acetonitrile. After thorough mixing, the slurry was cast onto carbon coated aluminum foil using a doctor blade, dried at ambient conditions two hours and then placed in a vacuum oven at 60° C. overnight. Finished cathode films had a final total solids loading of 8.2 to 9.2 mg/cm².

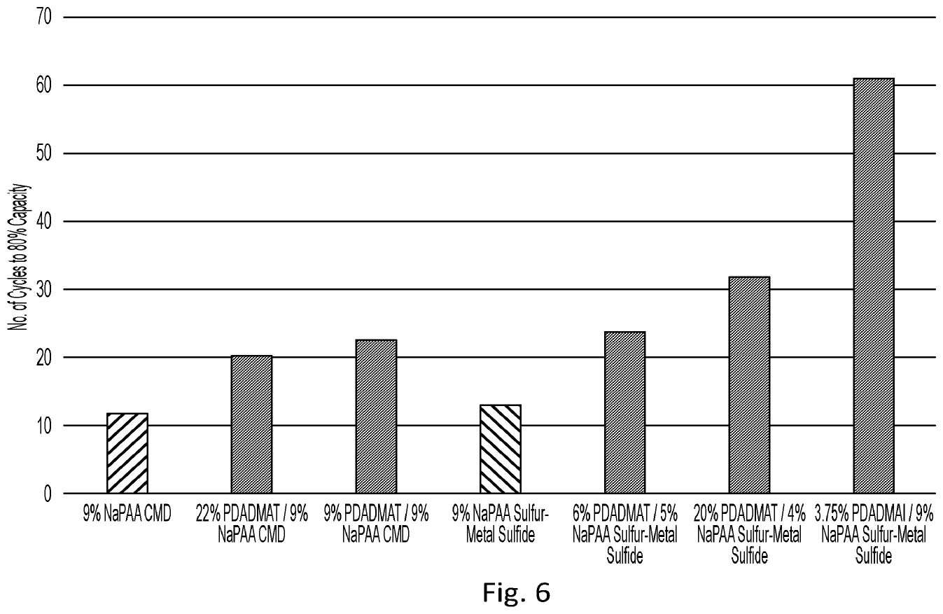

The mass percentages of the Lewis Acid and Lewis Base components in cathode films made according to the procedures above were varied to evaluate the impact of different ratios of the two components. Representative compositions that were evaluated are described in the legend of FIG. 6.

### Example 5: Preparation of Cathodes with Comparative Prior Art Binders

### Example 5a Preparation of a Sulfur Metal-Sulfide Cathode with PAA Binder (Sulfur Metal-Sulfide Sodium Polyacrylate)

A mixture of ethanol, an aqueous solution of PAA-Na, and conductive carbon were mixed in a FlackTek SpeedMixer™ to form a slurry. Ethanol and a powder composed of 70% sulfur and 30% TiS₂ by weight were added at intervals. The slurry was cast onto carbon coated aluminum foil to form a cathode film. The cathode was dried at ambient conditions for two hours then placed in a vacuum oven at 60° C. overnight. Finished cathode films had a final total solids loading of 7.0 to 7.8 mg/cm²

### Example 5b Preparation of a Sulfur-Carbon Cathode with PAA Binder (CMD, Sodium Polyacrylate)

A mixture of ethanol, an aqueous solution of PAA-Na, and conductive carbon were mixed in a FlackTek SpeedMixer™ to form a slurry. Ethanol and a powder composed of 80% sulfur and 20% carbon were added at intervals. The slurry was cast onto carbon coated aluminum foil using a doctor blade. The cathode was dried under ambient conditions for two hours, and then placed in a vacuum oven at 60° C. overnight. Cathode films had a final total solids loading of 6.5 to 7.3 mg/cm².

### Example 6: Preparation and Testing of Coin Cells Constructed with Cathodes Formulated with Supramolecular and Non Supramolecular Binders

Preparation of coin cells: Punches of the dried cathode films described in Examples 4a, 4b, 5a, and 5b were assembled into coin cells using Celgard™ separators and lithium metal anodes. Each cell was loaded with enough electrolyte to provide an E/S ratio of 4 μL/mg-S. Each cell was provided with a conventional Li-FSI based electrolyte (0.8 M LiFSI, 0.3 M LiNO₃ in DOL/DME). Five cells containing each cathode composition were cycled using a Maccor battery test system according to the following protocol: cells were cycled 5 times at the following respective rates 100 mA/g for one cycle, 200 mA/g for two cycles, and 333 mA/g for two cycles, in order to equilibrate the cells and prepare them for cycle life testing. The initial equilibration procedure was followed by a cycle life test consisting of a 20 cycle loop. Each loop consists of 1 cycle at 100 mA/g charge and discharge followed by 19 cycles at 333 mA/g charge and discharge.

Cycle life testing of coin cells: The cycle life of the cells was assessed by measuring the number of cycles completed before the measured discharge capacity declined to 80% of the cells initial capacity. As shown in FIG. 6, cells with supramolecular binders (solid bars) have higher cycle life than comparative cells with only NaPAA (hashed bars). This trend is consistent for both traditional carbon-sulfur cathodes (carbon melt diffusion or CMD) and for hybrid sulfur metal sulfide cathodes (SMS).

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between.

Headers have been provided for the convenience of the reader and are not intended to be limiting with respect to the claimed subject matter.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

1. An electrode (e.g., cathode) composition for a (e.g., lithium sulfur) battery, the composition comprising an electrochemically active material and a binder, wherein the binder comprises chemically interacting Lewis acid sites and Lewis base sites.

2. The electrode composition of claim 1, wherein the binder comprises two different species, each comprising either the Lewis acid sites or the Lewis base sites.

3. The electrode composition of claim 2, wherein one of the two different species is a polymer (e.g., an ionomer) and the other of the two different species is a particle (e.g., a nanoparticle).

4. The electrode composition of claim 3, wherein the particle is a silica particle, a metal oxide particle or a metal fluoride particle.

5. The electrode composition of claim 3 or claim 4, wherein the particle is porous (e.g., mesoporous).

6. The electrode composition of claim 2, wherein the two different species are different polymers (e.g., two ionomers).

7. The electrode composition of claim 6, wherein one of the two different species is a cationic polymer and the other of the two different species is an anionic polymer.

8. The electrode composition of any one of the preceding claims, wherein the binder in the composition forms a network of nodes at which the Lewis acid sites and the Lewis base sites are chemically interacting.

9. The electrode composition of claim 8, wherein the binder comprises two different species, one of which comprises the Lewis acid sites and the other of which comprises the Lewis base sites.

10. The electrode composition of any one of the preceding claims, wherein a first species comprises either the Lewis acid sites or the Lewis base sites and is soluble in an aqueous solvent, and wherein a different, second species comprises the other of the Lewis acid sites and the Lewis base sites and is insoluble in aqueous solution [e.g., wherein the water-insoluble species is a particle (e.g., nanoparticle)].

11. The electrode composition of claim 10, wherein the first species comprises the Lewis acid sites and is water-insoluble and the second species comprises the Lewis base sites and is water-soluble (e.g., wherein the binder is introduced into the composition as a slurry that comprises the water-soluble second species and the water-insoluble first species that is a particle).

12. The electrode composition of any one of the preceding claims, wherein the binder comprises a water soluble portion and a water insoluble portion that are chemically interacting.

13. The electrode composition of any one of the preceding claims, wherein the binder comprises particles comprising only the Lewis acid sites or only the Lewis base sites.

14. The electrode composition of any one of the preceding claims, wherein the binder comprises linear polymer comprising only the Lewis acid sites or only the Lewis base sites.

15. The electrode composition of any one of the preceding claims, wherein the binder comprises one or more polymers having the Lewis acid sites and/or the Lewis base sites incorporated into its/their polymer backbone(s) in the form of functional groups.

16. The electrode composition of claim 15, wherein the binder defines (e.g., forms) a supramolecular polymer network in the composition.

17. The electrode composition of any one of the preceding claims, wherein the binder comprises a neutral species (e.g., comprising boron centers) that comprises the Lewis acid sites or the Lewis base sites.

18. The electrode composition of any one of the preceding claims, wherein the binder comprises a species that decorates a surface of the electrochemically active material.

19. The electrode composition of any one of the preceding claims, wherein particles comprise the electrochemically active material and the binder comprises a species that decorates the particles.

20. The electrode composition of any one of the preceding claims, wherein the electrochemically active material comprises one or more members selected from the group consisting of sulfur (e.g., sulfur in its S₈ cyclic octatomic molecular form), lithium sulfide (e.g., Li₂S₂ and/or Li₂S), a chalcogenide (e.g., a metal sulfide), and an organosulfur.

21. The electrode composition of any one of the preceding claims, comprising an electron conducting material (e.g., a conductive carbon).

22. The electrode composition of claim 21, wherein the binder comprises a species that decorates a surface of the electron conducting material.

23. The electrode composition of claim 21 or claim 22, wherein particles comprise the electron conducting material and the binder comprises a species that decorates the particles.

24. The electrode composition of any one of claims 21-23, wherein the electron conducting material is a conductive carbon that is a conductive carbon powder (e.g., carbon black, Super P®, C-NERGY™ Super C65, Ensaco® black, Ketjenblack®, acetylene black, synthetic graphite such as Timrex® SFG-6, Timrex® SFG-15, Timrex® SFG-44, Timrex® KS-6, Timrex® KS-15, Timrex® KS-44, natural flake graphite, graphene, carbon nanotubes, fullerenes, hard carbon, and/or mesocarbon microbeads).

25. The electrode composition of any one of the preceding claims, wherein the binder comprises a first member selected from the group consisting of cationic polymers and a second member selected from anionic polymers.

26. The electrode composition of claim 25 wherein the first member comprises a polymer containing an ammonium group or a cationic heterocyclic group, or wherein the first member comprises ammonium, pyridinium, or imidazolium, or wherein the first member comprises poly(diallyldimethylammonium), poly(3-vinylimidazolium).

27. The electrode composition of claim 26 wherein the first member further comprises an anion selected from carboxylate, FSI, TFSI, BF4-, iodide, nitrate, or hexafluorophosphate, or wherein the first member further comprises an anion selected from FSI and TFSI.

28. The electrode composition of claim 25, wherein the second member is from the group of anionic polymers comprising functional groups selected from of carboxylates, sulfonates, phosphates, borates, thiosulfates, thionates, thiocarboxylates, dithiocarbamates, carbamates, thiocarbamates, xanthates, thiocarboxylates, dithiocarboxylates, carbonates, monothiocarbonates, dithiocarbonates, trithiocarbonates, hexafluorophosphates, thiophosphates, and borates.

29. A lithium-sulfur battery comprising a cathode comprising the electrode composition of any one of the preceding claims (e.g., wherein the electrode composition is disposed as a coating on a current collector).

30. A method for manufacturing a composition [e.g., an electrode composition (e.g., of any one of claims 1 to 28)], the method comprising:
combining components of a binder together in a slurry (e.g., with an electrochemically active material), wherein the components comprise a species soluble in the slurry and a species insoluble in the slurry; and
chemically interacting the soluble species and the insoluble species to form the binder (e.g., that binds the electrochemically active material).

31. The method of claim 30, wherein the soluble species comprises Lewis base sites or Lewis acid sites and the insoluble species comprises Lewis acid sites or Lewis base sites, respectively, and the chemically interacting comprises interacting the Lewis acid sites and the Lewis base sites.

32. The method of claim 31, wherein the soluble species comprises the Lewis base sites and the insoluble species comprises the Lewis acid sites.

33. The method of any one of claims 30-32, wherein the slurry is an aqueous slurry.

34. The method of any one of claims 30-33, wherein the insoluble species is a particle or a linear polymer.

35. The method of any one of claims 30-34, wherein the soluble species is a polymer (e.g., a linear polymer).

36. The method of any one of claims 30-35, comprising, prior to the combining, forming the insoluble species, wherein forming the insoluble species comprises performing a metathesis (e.g., anion metathesis) with precursor materials [e.g., resulting in precipitating product (e.g., the insoluble species].

37. The method of claim 36, wherein the precursor materials comprise one or more materials comprising one or more first anions selected from the group consisting of trifluoroacetate, trifluoromethanesulfonate, 2-trifluoromethyl-4,5-dicyanoimidazole, bis(trifluoromethane) sulfonimide (“TFSI”), and tetrafluoroborate (e.g., wherein the one or more anions is/are chosen to minimize their mass fraction in the product, thus achieving a higher mass content of cationic polymer units).

38. The method of claim 36 or claim 37, wherein the metathesis is performed in water and the insoluble species is insoluble in water.

39. The method of claim 36 or claim 37, wherein the metathesis is performed in a non-water solvent and the insoluble species is insoluble in water.

40. The method of any one of claims 36-39, wherein forming the insoluble species comprises performing a second metathesis (e.g., anion metathesis) (e.g., on the resulting product from the first metathesis) in a non-aqueous solvent (e.g., acetonitrile).

41. The method of claim 40, wherein the second metathesis is performed using one or more materials comprising one or more second anions.

42. The method of claim 41, wherein the one or more second anions are selected from the group consisting of tetrafluoroborate and bis(fluoro) sulfonamide.

43. The method of claim 41 or claim 42, wherein the first one or more anions is/are different from the one or more second anions.

44. The method of any one of claims 41-43, wherein the one or more second anions is/are lighter than the one or more first anions.

45. The method of any one of claims 41-44, wherein the one or more first anions is TFSI and wherein the one or more second anions is tetrafluoroborate.

46. The method of any one of claims 40-45, comprising dissolving resulting product (e.g., precipitate) of the metathesis in the non-aqueous solvent used to perform the second metathesis.

47. The method of any one of claims 30-46, comprising decorating an electrochemically active material with the insoluble species prior to the combining.

48. The method of claim 47, comprising forming the insoluble species, wherein forming the insoluble species comprises performing a metathesis in presence of the electrochemically active material (e.g., particles of electrochemically active material) and the decorating occurs during the metathesis.

49. The method of claim 48, wherein the metathesis is performed in water and the electrochemically active material is water insoluble (e.g., is a carbon sulfur active material).

50. The method of claim 47, comprising forming the insoluble species, wherein forming the insoluble species comprises performing a first metathesis and a subsequent second metathesis, wherein the subsequent second metathesis, but not the first metathesis, is performed in presence of the electrochemically active material (e.g., particles of electrochemically active material) and the decorating occurs during the second metathesis.

51. The method of claim 50, wherein the electrochemically active material is soluble in a solvent used for the first metathesis and insoluble in a solvent used for the second metathesis.

52. The method of claim 51, wherein the electrochemically active material is water soluble.

53. The method of any one of claims 50-52, wherein the electrochemically active material comprises a metal sulfide.

54. The method of any one of claims 30-53, comprising decorating an electron conducting material (e.g., conductive carbon) with the insoluble species prior to the combining.

55. The method of claim 54, comprising forming the insoluble species, wherein forming the insoluble species comprises performing a metathesis in presence of the electrochemically active material (e.g., particles of electrochemically active material) and the decorating occurs during the metathesis.

56. The method of claim 55, wherein the metathesis is performed in water and the electron conducting material is water insoluble.

57. The method of any one of claims 30-56, wherein the chemically interacting occurs at room temperature and/or in ambient atmosphere.

58. The method of any one of claims 30-57, wherein the chemically interacting occurs spontaneously upon combining the components together.

59. A method of preparing a species for use in a binder, the method comprising performing a metathesis to substitute a counterion in the species such that solubility of the species in a solvent changes from soluble to insoluble or from insoluble to soluble.

60. The method of claim 59, wherein the species changes from soluble in the solvent to insoluble in the solvent.

61. The method of claim 59 or claim 60, comprising performing the metathesis in presence a material (e.g., particles of the material) such that the species decorates the material.

62. The method of any one of claims 56-58, comprising performing the metathesis in presence a material (e.g., particles of the material) such that the species decorates a surface of the material.

63. The method of any one of claims 59-62, wherein the material is electrochemically active material or electron conducting material.

64. A composite comprising a material and a binder, wherein the binder comprises chemically interacting Lewis acid sites and Lewis base sites.

65. The composition of claim 64, comprising particles comprising the material, wherein the binder binds the particles together.

66. The composition of claim 64 or claim 65, wherein the composition is a film (e.g., self-supporting film) (e.g., coating on a substrate).

67. The electrode composition of claim 3 or claim 5, wherein the particle is a metal sulfide particle or a carbon particle.

68. The method of any one of claims 30-58, wherein the soluble species comprises Lewis base sites and the insoluble species comprises Lewis acid sites.

69. The method of claim 68, wherein the insoluble species is a solid (e.g., particle) species.

70. The electrode of any one of claims 1-28, wherein the binder has been introduced into the electrode composition from a slurry that comprises a water-soluble species comprising the Lewis acid sites and a water-insoluble species comprising Lewis base sites.

71. The electrode of claim 70, wherein the water-insoluble species is a particle.

72. The method of any one of claims 30-58, 68, and 69, wherein the binder forms upon mixing a water-soluble species and a complementary water insoluble species (e.g., a first species comprising Lewis acid sites and a second species comprising Lewis base sites).

73. The method of any one of claims 30-58, 68, and 69, wherein the binder forms upon complete or partial drying of a slurry that contains a water-soluble species and a complementary water insoluble species (e.g., a first species comprising Lewis acid sites and a second species comprising Lewis base sites).
